(19) United States
(12) Patent Application Publication
(10) Pub. No.: US 2025/0187229 A1
(43) Pub. Date: Jun. 12, 2025

(54) METHODS AND COMPOSITIONS FOR TREATMENT OF CONCRETE WASH WATER

(71) Applicant: CARBONCURE TECHNOLOGIES INC., Dartmouth (CA)

(72) Inventors: George Sean MONKMAN, Halifax (CA); Mark MACDONALD, Sackville (CA); Dean Paul FORGERON, Bayside (CA)

(21) Appl. No.: 18/972,931

(22) Filed: Dec. 7, 2024

Related U.S. Application Data
(63) Continuation of application No. 18/203,599, filed on May 30, 2023.
Application No. 18/203,599 is a continuation of application No. 16/155,013, filed on Oct. 9, 2018, now Pat. No. 11,660,779.
Application No. 16/155,013 is a continuation of application No. PCT/CA2017/050445, filed on Apr. 11, 2017.
(60) Provisional application No. 62/321,013, filed on Apr. 11, 2016.

(51) Int. Cl. B28C 5/00; B28C 5/42; B28C 7/02; B28C 7/12; C02F 1/52; C02F 1/66; C02F 103/12; C04B 22/00; C04B 28/04; C04B 28/08; C04B 40/02

(52) U.S. Cl. CPC B28C 5/003; B28C 5/00; B28C 5/42; B28C 7/02; B28C 7/024; B28C 7/12; C02F 1/5209; C02F 1/5236; C02F 1/66; C04B 22/0046; C04B 28/04; C04B 28/08; C04B 40/02; C04B 40/029; C02F 2103/12

(57) ABSTRACT

The invention provides methods and compositions for treating wash water from concrete production with carbon dioxide. The treated wash water can be reused as mix water in fresh batches of concrete.

### CROSS-REFERENCE

This application is a continuation of U.S. application Ser. No. 18/203,599, filed May 30, 2023, which is a continuation of U.S. application Ser. No. 16/155,013, filed on Oct. 9, 2018, which is a continuation of PCT Application No. PCT/CA2017/050445, filed on Apr. 11, 2017, which claims the benefit of U.S. Provisional Application No. 62/321,013, filed Apr. 11, 2016, the contents of which are incorporated herein by reference in their entireties.

### BACKGROUND OF THE INVENTIONS

Wash water, produced in the making of concrete, poses a significant problem in terms of use and/or disposal. Methods and compositions to better manage concrete wash water are needed.

### SUMMARY OF THE INVENTION

In one aspect the invention provides methods.

In certain embodiments, the invention provides a method of preparing a concrete mix comprising (i) adding concrete materials to a mixer; (ii) adding mix water to the mixer, wherein the mix water comprises carbonated concrete wash water; and (iii) mixing the water and the concrete materials to produce a concrete mix. In certain embodiments, the carbonated concrete wash water comprises at least 10% of the total mix water. In certain embodiments, the carbonated concrete mix water comprises at least 40% of the total mix water. In certain embodiments, the mix water comprises a first portion of water that is not carbonated mix water and a second portion of mix water that comprises carbonated mix water, wherein the first batch of mix water is added to the concrete materials before the second batch of mix water. The first portion of water can added at a first location and the second portion of water can added at a second location, e.g., the drum of a ready-mix truck, wherein the first and second locations are different. In certain embodiments, the second portion of mix water is added at least 2 minutes after the first portion. In certain embodiments, the carbonated concrete wash water has a density of at least 1.10 g/cm³. In certain embodiments, the carbonated concrete wash water has been held for at least 1 day. In certain embodiments, the carbonated concrete wash water has been held for at least 3 days In certain embodiments, the concrete mix is sufficiently workable for its intended use, and the carbonated wash water is of an age that the same mix made with the wash water of the same age in the same proportions would not be sufficiently workable for its intended use. In certain embodiments, the mix water comprises carbonated wash water in an amount that results in a concrete mix that is at least 1, 2, 3, 4, 5, 6, 7, 8, 9, 10, 12, 15, 20, 25, 30, 40, or 50%, for example 5%, stronger at a time after pouring—e.g., 1 day, 7 days, 28 days, or any combination thereof—than the same concrete mix made without carbonated wash water. In certain embodiments, the mix water comprises carbonated wash water in an amount that allows the concrete mix to contain at least 1, 2, 3, 4, 5, 6, 7, 8, 9, 10, 11, 12, 13, 14, 15, 16, 17, 18, 19, 20, 22, 25, 30, 40, or 50%, for example at least 5%, less cement than, and retain a compressive strength after pouring of within 1, 2, 3, 4, 5, 6, 7, 8, 9, 10, 12, 15, 20, 25, 30, 40, or 50%, for example at least 5%, of the same concrete mix made without carbonated wash water and with the extra (normal mix) percentage cement.

In another aspect, the invention provides apparatus.

In certain embodiments, the invention provides an apparatus for carbonating wash water produced in the production of concrete in a wash water operation wherein the wash water comprises cement and/or supplementary cementitious materials (SCM), comprising (i) a source of carbon dioxide; (ii) a first conduit operably connected to the source of carbon dioxide that runs to a wash water container, wherein (a) the wash water container contains wash water from a concrete production site; (b) the conduit has one or more openings positioned to deliver carbon dioxide at or under the surface of the wash water in the container to produce carbonated wash water; (iii) a system to transport the carbonated wash water to a concrete mix operation where the carbonated wash water is used as mix water in a concrete mix. The apparatus can further include (iv) a controller that determines whether or not, and/or how, to modify delivery of carbon dioxide to the wash water, or another characteristic of the wash water operation, or both, based on the one or more characteristics of the wash water or wash water operation. The characteristic can be, e.g., at least one, at least two, at least three, at least four, at least five, or at least six, of pH of the wash water, rate of delivery of carbon dioxide to the wash water, total amount of wash water in the wash water container, temperature of the wash water, specific gravity of the wash water, concentration of one or more ions in the wash water, age of the wash water, circulation rate of the wash water, timing of the circulation of the wash water, or timing of circulation of the wash water. In certain embodiments, the apparatus may further include (v) one or more sensors that monitor one or more characteristics of the wash water and/or the carbonation of the wash water in the container, wherein the one or more sensors is operably connected to the controller and delivers information regarding the characteristic of the wash water and/or wash water operation to the controller. In certain embodiments, the apparatus includes at least one, two, three, four, five, or six of sensors for (a) pH of the wash water, (b) rate of delivery of carbon dioxide to the wash water, (c) total amount of wash water in the wash water container, (d) temperature of the wash water, (e) specific gravity of the wash water, (f) concentration of one or more ions in the wash water, (g) age of the wash water, (h) circulation rate of the wash water, (i) timing of circulation of the wash water, or any combination thereof The apparatus may further include (iii) one or more actuators operably connected to the controller to modify delivery of carbon dioxide to the wash water, or another characteristic of the wash water operation, or both.

In certain embodiments, the invention provides an apparatus for preparing a concrete mix comprising (i) a first mixer for mixing concrete materials and water; (ii) a second mixer for mixing concrete materials and water; (iii) a first water container holding water that comprises carbonated concrete wash water; (iv) a second water container, different from the first, holding water that is not carbonated concrete wash water; (iv) a first system fluidly connecting the first water container with the second mixer and a second system fluidly connecting the second water container with the first mixer. The first and second mixers can be the same mixer; in certain embodiments, they are different mixers. In certain embodiments, the first mixer is the drum of a ready-mix truck. In certain embodiments, the apparatus further includes a controller configured to add a first amount of the water in the second water container to the first mixer at a first time and to add a second amount of the water in the first water container to the second mixer at a second time, wherein the first and second times are different and wherein the first time is before the second time.

In certain embodiments, the invention provides an apparatus for preparing a concrete mix comprising (i) a mixer for mixing concrete materials and water; (ii) a first water container holding water that comprises carbonated concrete wash water; (iii) a second water container, different from the first, holding water that is not carbonated concrete wash water; (iv) a third container, fluid connected to the first and second water containers and to the mixer, for receiving a first portion of the water in the first container and a second portion of the water in the second container, mixing them to form mixed waters, and sending a third portion of the mixed waters to the mixer.

### Incorporation By Reference

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows set acceleration in concrete produced with wash (grey) water at various specific gravities and ages, where the water was with and without carbon dioxide treatment. See Example 1.

FIG. 2 shows set acceleration in concrete produced with wash (grey) water produced with Ordinary Portland Cement (OPC, 50%) and supplementary cementitious materials (SCM, 50%), where the water was treated and untreated with carbon dioxide, and aged 1 or 6 days.

FIG. 3 shows workability (slump) in concrete produced with wash (grey) water produced with Ordinary Portland Cement (OPC, 50%) and supplementary cementitious materials (SCM, 50%), where the water was treated and untreated with carbon dioxide, and aged 1 or 6 days.

FIG. 4 shows set acceleration in concrete produced with wash (grey) water produced with Ordinary Portland Cement (OPC, 100%), where the water was treated and untreated with carbon dioxide, and aged 1 or 6 days.

FIG. 5 shows workability (slump) in concrete produced with wash (grey) water produced with Ordinary Portland Cement (OPC, 100%), where the water was treated and untreated with carbon dioxide, and aged 1 or 6 days.

FIG. 6 shows set acceleration in concrete produced with wash (grey) water produced with Ordinary Portland Cement (OPC, 100%), where the water was treated and untreated with carbon dioxide, and aged 1 or 6 days, in a large number of different specific gravities.

FIG. 7 shows calorimetry, as power vs. time, for concrete produced with wash (grey) water produced with Ordinary Portland Cement (OPC, 100%), where the water was treated and untreated with carbon dioxide, and for concrete prepared with potable water.

FIG. 8 shows calorimetry, as energy vs. time, for concrete produced with wash (grey) water produced with Ordinary Portland Cement (OPC, 100%), where the water was treated and untreated with carbon dioxide, and for concrete prepared with potable water.

FIG. 9 shows set acceleration in concrete produced with wash (grey) water produced with Ordinary Portland Cement (OPC, 100%), where the wash water was treated with carbon dioxide continuously, at 2 hours after preparation of wash water, or just prior to use in the concrete.

FIG. 10 shows workability (slumpP in concrete produced with wash (grey) water produced with Ordinary Portland Cement (OPC, 100%), where the wash water was treated with carbon dioxide continuously, at 2 hours after preparation of wash water, or just prior to use in the concrete.

FIG. 11 shows 24-hour compressive strengths for concrete produced with various wash waters, where the wash water was treated or not treated with carbon dioxide.

FIG. 12 shows set acceleration in concrete prepared with wash water treated or not treated with carbon dioxide and held at two different temperatures.

FIG. 13 shows strength enhancement at 7 days for concrete produced with various wash waters, where the wash water was treated or not treated with carbon dioxide.

FIG. 14 shows strength enhancement at 28 days for concrete produced with various wash waters, where the wash water was treated or not treated with carbon dioxide.

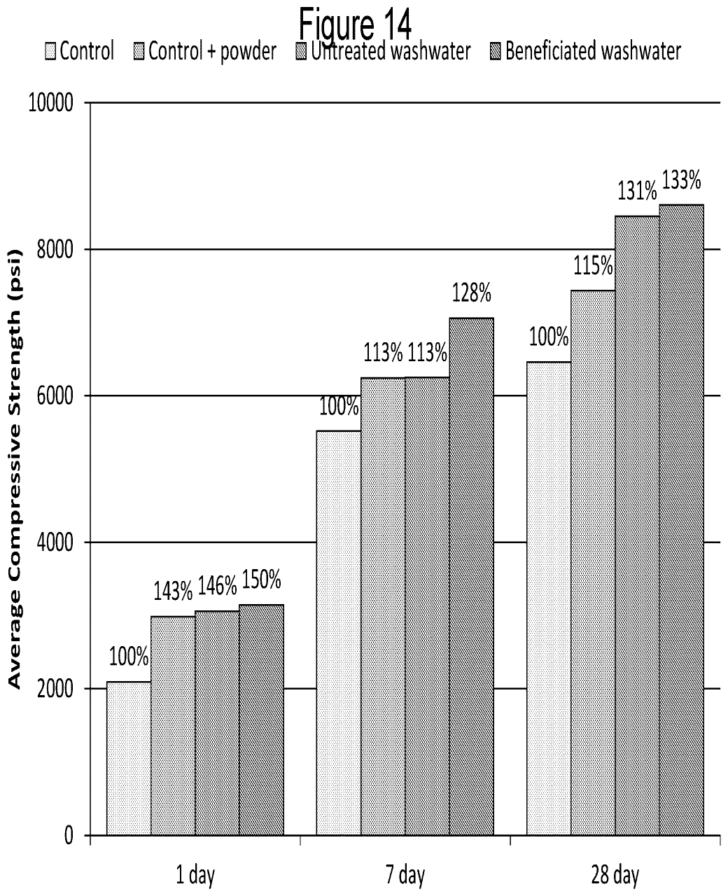

FIG. 15 shows set times for mortar cubes made with wash water treated or untreated with carbon dioxide, and sitting for 1 day or 7 days.

FIG. 16 shows set times at 1 day relative to 7 days.

FIG. 17 shows set mortar slump mortar cubes made with wash water treated or untreated with carbon dioxide, and sitting for 1 day or 7 days.

FIG. 18 shows mortar slump for water held at 7 days relative to slump for water held at 1 day.

FIG. 19 shows carbon dioxide uptake of solids in wash water relative to time of treatment with carbon dioxide.

FIG. 20 shows pH of wash water relative to time of treatment with carbon dioxide.

FIG. 21 shows one-day strength of mortar cubes made with wash water treated with carbon dioxide for various times and aged 1 day.

FIG. 22 shows 7-day strength of mortar cubes made with wash water treated with carbon dioxide for various times and aged 1 day.

FIG. 23 shows 28-day strength of mortar cubes made with wash water treated with carbon dioxide for various times and aged 1 day.

FIG. 24 shows one-day strength of mortar cubes made with wash water treated with carbon dioxide for various times and aged 7 days.

FIG. 25 shows 7-day strength of mortar cubes made with wash water treated with carbon dioxide for various times and aged 7 days.

FIG. 26 shows 28-day strength of mortar cubes made with wash water treated with carbon dioxide for various times and aged 7 days.

FIG. 27 shows slump in mortar cubes made with wash waters treated or untreated with carbon dioxide.

FIG. 28 shows 1-day compressive in mortar cubes made with wash waters treated or untreated with carbon dioxide.

FIG. 29 shows 7-day compressive in mortar cubes made with wash waters treated or untreated with carbon dioxide.

FIG. 30 shows 28-day compressive in mortar cubes made with wash waters treated or untreated with carbon dioxide.

FIG. 31 shows calcium ICP-OES analysis of filtrate of wash waters treated or untreated with carbon dioxide

FIG. 32 shows potassium ICP-OES analysis of filtrate of wash waters treated or untreated with carbon dioxide

FIG. 33 shows sodium ICP-OES analysis of filtrate of wash waters treated or untreated with carbon dioxide

FIG. 34 shows strontium ICP-OES analysis of filtrate of wash waters treated or untreated with carbon dioxide

FIG. 35 shows sulfur ICP-OES analysis of filtrate of wash waters treated or untreated with carbon dioxide

FIG. 36 shows silicon ICP-OES analysis of filtrate of wash waters treated or untreated with carbon dioxide

FIG. 37 shows CO2 treatment decreased pH of filtrate of wash waters.

FIG. 38 shows data of FIGS. 31-36 in Tabular form.

FIG. 39 shows data of FIGS. 31-36 in Tabular form.

FIG. 40 shows scanning electron micrographs (SEM) for particles in wash waters (100% OPC) treated or untreated with carbon dioxide, 250× magnification.

FIG. 41 shows scanning electron micrographs (SEM) for particles in wash waters (100% OPC) treated or untreated with carbon dioxide, 1000× magnification.

FIG. 42 shows scanning electron micrographs (SEM) for particles in wash waters (100% OPC) treated or untreated with carbon dioxide, 25,000× magnification.

FIG. 43 shows scanning electron micrographs (SEM) for particles in wash waters (75% OPC/25% slag) treated or untreated with carbon dioxide, 250× magnification

FIG. 44 shows scanning electron micrographs (SEM) for particles in wash waters (75% OPC/25% slag) treated or untreated with carbon dioxide, 3500× magnification.

FIG. 45 shows scanning electron micrographs (SEM) for particles in wash waters (75% OPC/25% slag) treated or untreated with carbon dioxide, 25,000× magnification

FIG. 46 shows X-ray diffraction (XRD) patterns from wash waters treated or untreated with carbon dioxide.

FIG. 47 shows X-ray diffraction (XRD) patterns from wash waters treated or untreated with carbon dioxide.

FIG. 48 shows nuclear magnetic resonance (NMR) patterns from wash waters treated or untreated with carbon dioxide.

FIG. 49 shows nuclear magnetic resonance (NMR) patterns from wash waters treated or untreated with carbon dioxide.

FIG. 50 shows the results for compressive strength of mortar cubes made with one-day old wash water subject to continuous agitation, wash water solids and mortar at 25% slag/75% OPC (Cemex Cemopolis cement).

FIG. 51 shows the results for compressive strength of mortar cubes made with one-day old wash water subject to continuous agitation, wash water solids and mortar at 25% class C fly ash/75% OPC (Cemex Cemopolis cement).

FIG. 52 shows the results for compressive strength of mortar cubes made with one- day old wash water subject to continuous agitation, wash water solids and mortar at 25% class F fly ash/75% OPC (Cemex Cemopolis cement).

FIG. 53 shows the results for compressive strength of mortar cubes made with one-day old wash water subject to continuous agitation, wash water solids and mortar at 100% OPC (Cemex Cemopolis cement).

FIG. 54 shows the results for compressive strength of mortar cubes made with seven-day old wash water subject to continuous agitation, wash water solids and mortar at 100% OPC (Cemex Cemopolis cement).

FIG. 55 shows effects of untreated and carbon dioxide-treated wash water used in mortar cubes on set times of the mortar cubes.

FIG. 56 shows the effects of untreated and carbon dioxide-treated wash water aged one day used in mortar cubes on compressive strengths of the mortar cubes.

FIG. 57 shows the effects of untreated and carbon dioxide-treated wash water aged five day used in mortar cubes on compressive strengths of the mortar cubes.

FIG. 58 shows the effects of untreated and carbon dioxide-treated wash water aged one to five day used in mortar cubes on compressive strengths of the mortar cubes.

### DETAILED DESCRIPTION OF THE INVENTION

Wash water, also called grey water herein, is produced as a byproduct of the concrete industry. This water, which may contain suspended solids in the form of sand, aggregate and/or cementitious materials, is generated through various steps in the cycle of producing concrete structures. Generally a large volume of concrete wash water is produced by the washing-out of concrete mixer trucks following the delivery of concrete. This water is alkaline in nature and requires specialized treatment, handling and disposal.

While this water can be suitable for reuse in the production of concrete, it has been documented that the wash water can result in negative impacts on the properties of concrete, namely set acceleration and loss of workability. Wash water is mainly a mixture of cement and, in many cases, supplementary cementitious materials (SCMs) in water. It becomes problematic as a mix water because as the cement hydrates it changes the chemistry of the water. These changes in chemistry, along with the hydration products, cause a host of issues when the water is used as mix water, such as acceleration, increased water demand, reduced 7-day strength, and the like. These issues generally worsen as the amount of cement in the water increases, and/or the water ages.

The methods and compositions of the invention utilize the application of CO₂ to concrete wash water to improve its properties for reuse in the production of concrete. Thus, wash water that has a cement content (e.g., specific gravity) and/or that has aged to a degree that would normally not allow its use as mix water can, after application of carbon dioxide, be so used.

Without being bound by theory, it is thought that by carbonating wash water, several results may be achieved that are beneficial in terms of using the water as part or all of mix water for subsequent batches of concrete:
1) Maintain a pH of ˜7: This effectively dissolves the cement due to the acidity of CO₂. This helps deliver a grey water of consistent chemistry and removes the “ageing effects”.
2) Precipitate any insoluble carbonates: CO₂ actively forms carbonate reaction products with many ions. This removes certain species from solution, such as calcium, aluminum, magnesium and others. This is another step that helps provide a grey water of consistent chemistry.
3) Change solubility of cement ions: The solubilities of many ions depend on pH. By maintaining the pH at ˜7 with CO₂ the nature of the water chemistry is changed, potentially in a favorable direction.
4) Shut down pozzolanic reactions: By maintaining the pH around 7 no Ca(OH)₂ is available to react with slag and/or fly ash in the grey water. This can mean that these SCMs are unaltered through the treatment and reuse of the grey water, thus reducing the impact of the grey water substantially.
5) Reduce amount of anions behind: The formation of carbonate precipitates using CO₂ is advantageous over other common acids, like HCl or H₂SO₄ whose anions, if left soluble in the treated water, can adversely impact the chemistry of the grey water for concrete batching.
6) Cause retardation. By saturating the grey water with CO₂/HCO3— retardation can be achieved when used as batch water.
7) Nature of precipitates: The process may potentially be altered to form precipitates that have less effects on the water demand of concrete prepared with grey water. In particular, conditions of carbonation may be used that produce nanocrystalline carbonates, such as nanocrystalline calcium carbonate, that are known to be beneficial when used in concrete products.

In certain embodiments, the invention provides a method of providing a mix water for a batch of concrete, where the mix water comprises wash water from one or more previous batches of concrete that has be exposed to carbon dioxide in an amount above atmospheric concentrations of carbon dioxide, to carbonate the wash water (“carbonated wash water.”. The mix water may contain at least 10, 20, 30, 40, 50, 60, 70, 80, 90, 95, 99, or 99.5% carbonated wash water. Alternatively or additionally, the mix water may contain no more than 20, 30, 40, 50, 60, 70, 80, 90, 95, 99, 99.5, or 100% carbonated wash water. In certain embodiments, the mix water is 100% carbonated wash water. In certain embodiments, the mix water is 1-100% carbonated wash water. In certain embodiments, the mix water is 1-80% carbonated wash water. In certain embodiments, the mix water is 1-50% carbonated wash water. In certain embodiments, the mix water is 1-30% carbonated wash water. In certain embodiments, the mix water is 10-100% carbonated wash water. In certain embodiments, the mix water is 20-100% carbonated wash water. In certain embodiments, the mix water is 50-100% carbonated wash water. In certain embodiments, the mix water is 70-100% carbonated wash water. In certain embodiments, the mix water is 90-100% carbonated wash water.

In certain embodiments, a first portion of mix water that is plain water, e.g., not wash or other water that has been carbonated, such as plain water as normally used in concrete mixes, is mixed with concrete materials, such as cement, aggregate, and the like, and then a second portion of mix water that comprises carbonated water, which can be carbonated plain water or, e.g., carbonated wash water is added. The first portion of water may be such that an acceptable level of mixing is achieved, e.g., mixing without clumps or without substantial amounts of clumps. For example, the first portion of mix water that is plain water may be 1-90%, or 1-80%, or 1-75%, or 1-70%, or 1-65%, or 1-60%, or 1-55%, or 1-50%, or 1-45%, or 1-40%, or 1-30%, or 1-20%, or 1-10% of the total mix water used in the concrete mix, while the remainder of the mix water used in the concrete mix is the second portion, i.e., carbonated mix water. The first portion of water may be added at one location and the second portion at a second location. For example, in a ready mix operation, the first portion may be added to concrete materials which are mixed, then the mixed materials are transferred to a drum of a ready-mix truck, where the second portion of water is added to achieve carbonation of the concrete in the drum of the ready-mix truck. However, it is also possible that both the first and the second locations are the same location, e.g., a mixer prior to deposit into a ready-mix truck, or the drum of the ready-mix truck. The second portion of water may be added at any suitable time after the addition of the first portion. In general, the second portion of water is added at least after the first portion and the concrete materials have mixed sufficiently to achieve mixing without clumps or without substantial amounts of clumps. In certain embodiments, the second portion of water is added at least 1, 2, 3, 4, 5, 6, 7, 8, 9, 10, 12, 15, 20, 25, 30, 40, 50, or 60 minutes after the first portion of water.

The wash water may be carbonated at any suitable time, for example, right after its production, at some time after production, or just before use in the concrete, or any combination thereof. For example, in certain embodiments, carbonation of wash water can commence no later than 1, 2, 5, 10, 20, 30, 40, 60, 80, 100, 120, 150, 180, 240, 300, 360, 420, or 480 minutes after formation of the wash water, and/or no sooner than 2, 5, 10, 20, 30, 40, 60, 80, 100, 120, 150, 180, 240, 300, 360, 420, 480, or 540 minutes after formation of the wash water. The carbonation can continue for any suitable period of time, for example, in certain embodiments wash water is continuously exposed to carbon dioxide for a period of time after carbonation commences. Alternatively or additionally, wash water can be carbonated just before its use as mix water, for example, no more than 1, 2, 5, 10, 20, 30, 40, 60, 80, 100, 120, 150, 180, 240, 300, 360, 420, or 480 minutes before its use as mix water (e.g., before contacting the concrete mixture), and/or no sooner than 2, 5, 10, 20, 30, 40, 60, 80, 100, 120, 150, 180, 240, 300, 360, 420, 480, or 540 minutes before its use as mix water.

In certain embodiments, the wash water is circulated before its use as a mix water. For example, part or all of the wash water that is carbonated may be circulated (e.g., run through one or more loops to, e.g., aid in mixing and/or reactions, or agitated, or stirred, or the like). This circulation may occur continuously or intermittently as the water is held prior to use. In certain embodiments the wash water is circulated for at least 5, 10, 20, 50, 70, 80, 90, 95, or 99% of the time it is held prior to use as mix water.

It will be appreciated that many different wash waters are typically combined and held, for example, in a holding tank, until use or disposal. Carbonation of wash water may occur before, during, or after its placement in a holding tank, or any combination thereof Some or all of the wash water from a given operation may be carbonated. It is also possible that wash water from one batch of concrete may be carbonated then used directly in a subsequent batch, without storage.

Any suitable method or combination of methods may be used to carbonate the wash water. The wash water may be held in a container and exposed to a carbon dioxide atmosphere while mixing. Carbon dioxide may be bubbled through mix water by any suitable method; for example, by use of bubbling mats, or alternatively or additionally, by introduction of carbon dioxide via a conduit with one or a plurality of openings beneath the surface of the wash water. The conduit may be positioned to be above the sludge that settles in the tank and, in certain embodiments, regulated so as to not significantly impede settling. Catalysts may also be used to accelerate one or more reactions in the carbonating wash water.

In certain cases, mix water, e.g., wash water may be treated with carbon dioxide in such a manner that the carbon dioxide content of the water increases beyond normal saturation, for example, at least 10, 20, 30, 40, 50, 70, 100, 150, 200, or 300% beyond normal saturation, compared to the same water under the same conditions that is normally saturated with carbon dioxide. Normal saturation is, e.g., the saturation achieved by, e.g., bubbling carbon dioxide through the water, e.g., wash water, until saturation is achieved, without using manipulation of the water beyond the contact with the carbon dioxide gas. For methods of treating water to increase carbon dioxide concentration beyond normal saturation levels, see, e.g., U.S. Patent Application Publication No. 2015/0202579.

In certain embodiments, the invention allows the use of wash water substantially “as is,” that is, without settling to remove solids. Carbonation of the wash water permits its use as mix water, even at high specific gravities.

This technology can allow the use of grey water as mix water, where the grey water is at specific gravities of at least 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.22, 1.25, 1.30, 1.35, 1.40, or 1.50, and/or not more than 1.02, 1.03, 1.04, 1.05, 1.06, 1.07, 1.08, 1.09, 1.10, 1.11, 1.12, 1.13. 1.14, 1.15, 1.16, 1.17, 1.18, 1.19, 1.20, 1.22, 1.25, 1.30, 1.35, 1.40, 1.50 or 1.60; e.g., 1.0-1.2, or 1.0 to 1.3, or 1.0 to 1.18, or 1.0 to 1.16, or 1.0 to 1.15, or 1.0 to 1.14, or 1.0 to 1.13, or 1.0 to 1.12, or 1.0 to 1.10, or 1.0 to 1.09, or 1.0 to 1.08, or 1.0 to 1.07, or 1.0 to 1.06, or 1.0 to 1.05, or 1.0 to 1.04, or 1.0 to 1.03, or 1.0 to 1.02, 1.01-1.2, or 1.01 to 1.3, or 1.01 to 1.18, or 1.01 to 1.16, or 1.01 to 1.15, or 1.01 to 1.14, or 1.01 to 1.13, or 1.01 to 1.12, or 1.01 to 1.10, or 1.01 to 1.09, or 1.01 to 1.08, or 1.01 to 1.07, or 1.01 to 1.06, or 1.01 to 1.05, or 1.01 to 1.04, or 1.01 to 1.03, or 1.01 to 1.02, or 1.02-1.2, or 1.02 to 1.3, or 1.02 to 1.18, or 1.02 to 1.16, or 1.02 to 1.15, or 1.02 to 1.14, or 1.02 to 1.13, or 1.02 to 1.12, or 1.02 to 1.10, or 1.02 to 1.09, or 1.02 to 1.08, or 1.02 to 1.07, or 1.02 to 1.06, or 1.02 to 1.05, or 1.02 to 1.04, or 1.02 to 1.03, or 1.03-1.2, or 1.03 to 1.3, or 1.03 to 1.18, or 1.03 to 1.16, or 1.03 to 1.15, or 1.03 to 1.14, or 1.03 to 1.13, or 1.03 to 1.12, or 1.03 to 1.10, or 1.03 to 1.09, or 1.03 to 1.08, or 1.03 to 1.07, or 1.03 to 1.06, or 1.03 to 1.05, or 1.03 to 1.04, or 1.05-1.2, or 1.05 to 1.3, or 1.05 to 1.18, or 1.05 to 1.16, or 1.05 to 1.15, or 1.05 to 1.14, or 1.05 to 1.13, or 1.05 to 1.12, or 1.05 to 1.10, or 1.05 to 1.09, or 1.05 to 1.08, or 1.05 to 1.07, or 1.05 to 1.06. In certain embodiments the methods and compositions of the invention allow the use of grey (wash) water as mix water, where the grey water has a specific gravity of at least 1.01, 1.02, 1.03, 1.04, 1.05, 1.06, 1.07. 1.08, 1.09, 1.10, 1.11, 1.12, 1.13, 1.14, 1.15, 1.16, 1.17, 1.18, 1.19, or 1.20.

The use of wash water in a concrete mix, especially carbonated wash water, often results in enhanced strength of the resulting concrete composition at one or more times after pouring, for example, an increase in compressive strength, when compared to the same concrete mix without carbonated wash water, of at least 1, 2, 3, 4, 5, 6, 7, 8, 9, 10, 12, 14, 16, 18, 20, 22, or 25% at 1-day, 7-days, and/or 28-days. This increase in early strength often allows the use of less cement in a mix that incorporates carbonated wash water than would be used in the same mix that did not incorporate carbonated wash water; for example, the use of 1, 2, 3, 4, 5, 6, 7, 8, 9, 10, 11, 12, 13, 14, 15, 16, 17, 18, 20, 22, 25, 30, 35, or 40% less cement in the mix where the mix retains a compressive strength at a time after pouring, e.g., at 1, 7, and/or 28-days, that is within 1, 2, 3, 4, 5, 6, 7, 8, 9, 10, 12, 15, 20, 30, 40, or 50% of the compressive strength of the mix that did not incorporate carbonated wash water, e.g., within 5%, or within 7%, or within 10%.

In addition, the carbonation of wash water can allow the use of wash water at certain ages that would otherwise not be feasible, e.g., wash water that has aged at least 1, 2, 3, 4, 5, 6, 7, 8, 9, 10, 12, or 15 days. Wash water that has been carbonated may be used in concrete at an age where it would otherwise produce a concrete mix without sufficient workability to be used.

The CO₂ treatment produces carbonate reaction products that likely contain some amount of nano-structured material. Of the carbonated products in the wash water, e.g., calcium carbonate, at least 1, 2, 5, 7, 10, 12, 15, 20, 25, 30, 25, 40, 45, 50, 60, 70, 80, or 90% may be present as nano-structured materials, and/or not more than 5, 7, 10, 12, 15, 20, 25, 30, 25, 40, 45, 50, 60, 70, 80, 90, 95, or 100% may be present as nano-structured material. A “nano-structured material,” as that term used herein, includes a solid product of reaction of a wash water component with carbon dioxide whose longest dimension is no more than 500 nm, in certain embodiments no more than 400 nm, in certain embodiment no more than 300 nm, and in certain embodiments no more than 100 nm.

The CO₂ treatment has the further benefit of sequestering carbon dioxide, as the carbon dioxide reacts with components of the wash water (typically cement or supplementary cementitious material), as well as being present as dissolved carbon dioxide/carbonic acid/bicarbonate which, when the wash water is added to a fresh concrete mix, further reacts with the cement in the mix to produce further carbon dioxide-sequestering products. In certain embodiments, the carbon dioxide added to the wash water results in products in the wash water that account for at least 1, 2, 5, 7, 10, 12, 15, 20, 25, 30, 25, 40, 45, 50, 60, 70, 80, or 90% carbon dioxide by weigh cement (bwc) in the wash water, and/or not more than 5, 7, 10, 12, 15, 20, 25, 30, 25, 40, 45, 50, 60, 70, 80, 90, 95, or 100% carbon dioxide by weigh cement (bwc) in the wash water.

Embodiments include applying CO₂ immediately after the wash water is generated, in a tank, and/or as the grey water is being loaded for batching.

Alternatively or additionally, carbonation of grey (wash) water can allow use of aged wash water as mix water, for example, wash water that has aged at least 1, 2, 3, 4, 5, 6, 7, 8, 9, or 10 days.

The source of the carbon dioxide can be any suitable source. In certain embodiments, some or all of the carbon dioxide is recovered from a cement kiln operation, for example, one or more cement kiln operations in proximity to the concrete production facility, e.g., one or more cement kiln operations that produce cement used in the concrete production facility.

Compositions of the invention include an apparatus for carbonating concrete wash water in a wash water operation that includes a source of carbon dioxide operably connected to a conduit that runs to a wash water container containing wash water from a concrete production site, where one or more openings of the conduit are positioned to deliver carbon dioxide at or under the surface of wash water in the container, or both, and a system to transport the carbonated wash water to a concrete mix operation where the carbonated wash water is used as mix water in a concrete mix, e.g. a second conduit that can be positioned to remove carbonated wash water from the wash water container and transport it to a concrete mix operation, where the carbonated wash water is used as part or all of mix water for concrete batches. Generally, the carbon dioxide will be delivered directly to the wash water tank as described elsewhere herein, though in some embodiments carbonation may occur outside the tank and the carbonated water returned to the tank. The apparatus may further include a controller that determines whether or not to modify the delivery of carbon dioxide based at least in part on one or more characteristics of the wash water or wash water operation. The characteristics may include one or more of pH of the wash water, rate of delivery of carbon dioxide to the wash water, total amount of wash water in the wash water container, temperature of the wash water, specific gravity of the wash water, concentration of one or more ions in the wash water, age of the wash water, circulation rate of the wash water, timing of circulation of the wash water, or any combination thereof. One or more sensors may be used for monitoring one or more characteristics of the wash water; additionally, or alternatively, manual measurements may be made periodically, e.g., manual measurements of specific gravity, pH, or the like. The apparatus may further comprise one or more actuators operably connected to the controller to modify delivery of carbon dioxide to the wash water, or another characteristic of the wash water, or both. The apparatus may include a system for moving the wash water, such as by circulating or agitating the wash water, either continuously or intermittently. The composition may further include a delivery system for delivering carbon dioxide to the source of carbon dioxide, where some or all of the carbon dioxide is derived from a cement kiln operation in proximity to the concrete production site, for example, a cement kiln operation that produces some or all of cement used in the concrete production site.

### EXAMPLES

### Example 1

Samples of grey (wash) water were prepared in the lab. Lab grey water was made by mixing cement with potable water. Specific gravity (SG) range of lab grey water was 1.025 to 1.100. Grey water was allowed to age for either 1 or 4 days before being used as mix water in the preparation of mortar samples. Set time of mortar was measured via penetrometer as per ASTM C403.

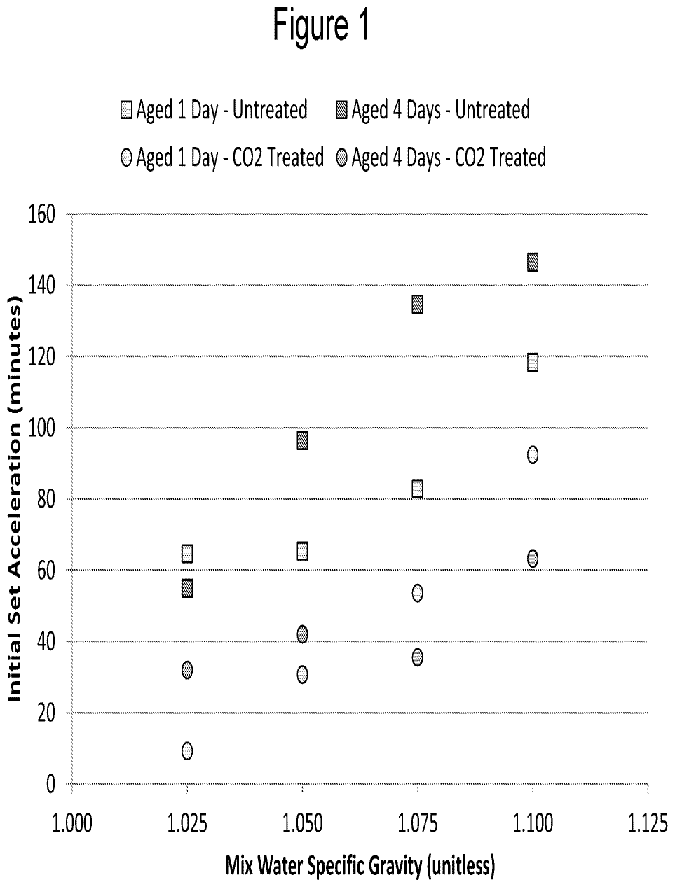

Set time. In FIG. 1, Acceleration is plotted relative to the set time for a sample made with potable water (SG=1.000). Both SG and age of grey water have large accelerating effect on mortar initial set.

A CO₂ treatment was applied to grey water samples in same age and SG range as previous set. As with untreated samples, acceleration is plotted relative to the set time for a sample made with potable water (SG=1.000) (FIG. 1).

Treatment of the grey water with CO₂ resulted in two main improvements: 1) Reduced acceleration: the amount of initial set acceleration was greatly reduced by the CO₂ treatment of the grey water; and 2) Reduction in age effects: the set time acceleration was not significantly influenced by aging of the CO₂ treated grey water samples

The reduction in acceleration and age effects helps address two of the primary obstacles associated with grey water reuse. First, the CO2 treatment opens the potential to correlate impacts of the grey water directly to the SG value of the sample regardless of age, and second, the reduction in the scale of the acceleration allows for simple modifications to admixture loadings to fine-tune set time.

### Example 2

This Example demonstrates that treatment of concrete wash water (grey water) with carbon dioxide improves set, workability, and other characteristics of concrete made using the wash water, and allows the use of wash water at higher specific gravity than the typical maximum allowed.

In a first set of tests, samples of wash water were produced in the lab by adding known amounts of cementitious materials to potable water sources. The samples of wash water were allowed to age for up to 6 days before being used as mix water in the preparation of mortar samples. Certain samples were subjected to CO₂ treatment, which included vigorous mixing and aging of the wash water under a CO₂ atmosphere. Typically the exposure to CO₂ was initiated in the timeframe of 30-120 minutes after preparation of the wash water and continued until the wash water was used for mortar preparation. Variations on the CO₂ treatment were deployed wherein a sample of wash water was only exposed to CO₂ once: either directly before use as mix water or in the time frame of 30-120 minutes after the wash water was prepared. The CO₂ treatments presented would result in CO₂ uptake on the order of 10-40% by weight of cement.

The proportions and properties of wash water prepared for this study are presented in Table 1, below. The density of cement was taken as 3.15 g/mL while the density of slag and class F fly ash were both taken as 2.2 g/mL. Grey water samples were prepared at additional specific gravity values using the same logic presented within this table.

TABLE 1
Compositions of Wash Waters used in the Example

| | | Mass | Mass | Mass | Mass | Final | Final |
|---|---|---|---|---|---|---|---|
| Wash | | of | of | of | of | Mixture | Mixture |
| Water | | water | cement | slag | fly ash | Density | Specific |
| Type | | (g) | (g) | (g) | (g) | (g/mL) | Gravity |
| 100% | OPC | 267.5 | 40 | 0 | 0 | 1.10 | 1.10 |
| 100% | OPC | 267.5 | 65 | 0 | 0 | 1.15 | 1.15 |
| 100% | OPC | 267.5 | 85 | 0 | 0 | 1.20 | 1.20 |
| 50% | SCMs | 267.5 | 23 | 14 | 9 | 1.10 | 1.10 |
| 50% | SCMs | 267.5 | 35 | 21 | 14 | 1.15 | 1.15 |
| 50% | SCMs | 267.5 | 49 | 29 | 20 | 1.20 | 1.20 |

The concrete wash water samples produced in the lab were used to produce mortar samples and assessed for their impact on fresh properties. The wash water samples were used to prepare mortar samples by combining with 1350 g sand and 535 g of cement in a bench-top paddle style mixer. Set time was measured in accordance with ASTM C403 using the penetrometer method. calorimetry was collect using a Calmetrix iCal8000. Set time and slump results were compared to mortar samples prepared with potable water

Set and Workability. All statements apply to both EF50 and 100% OPC grey water compositions

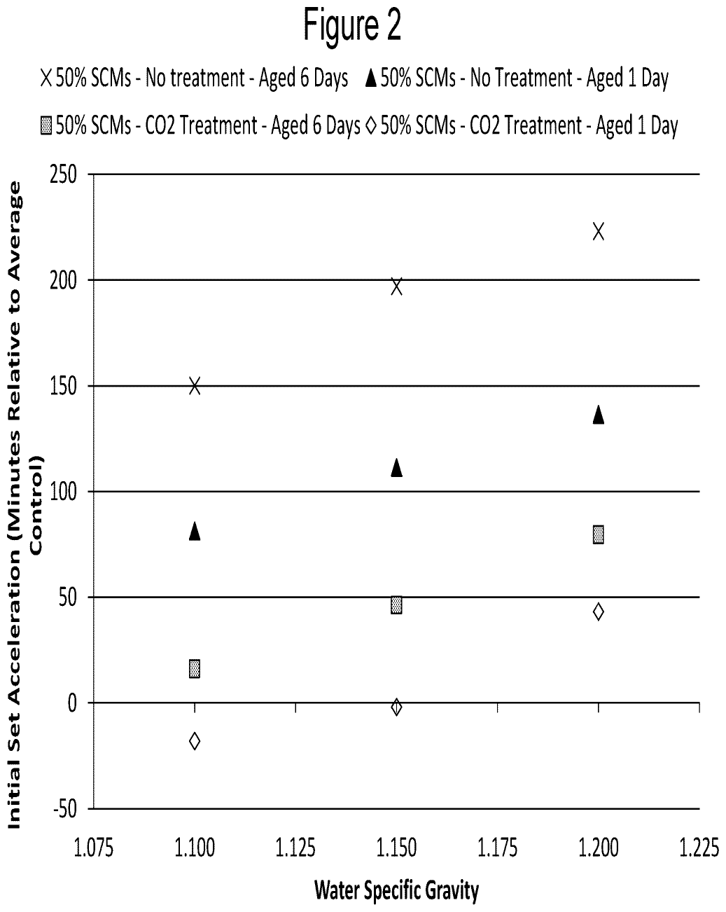

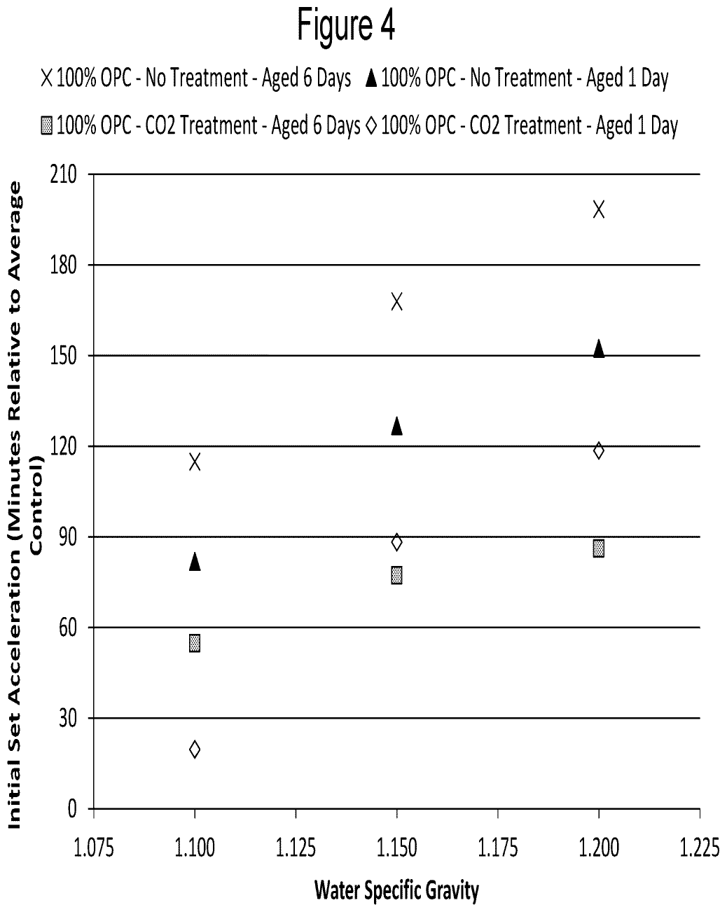

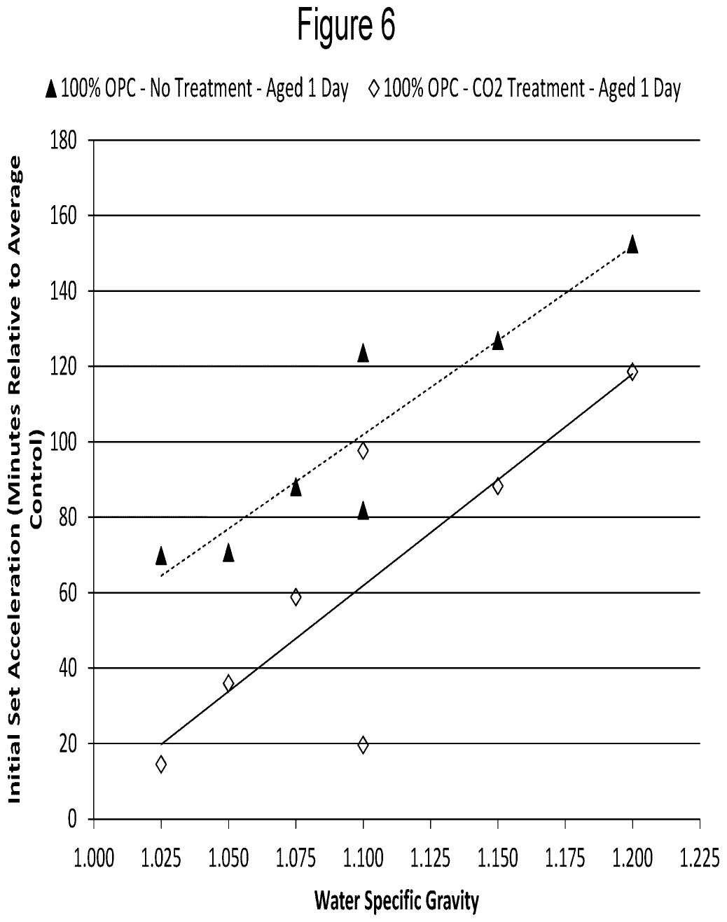

Set time. In all cases the CO2 treatment greatly reduced the acceleration caused by increases solid contents in the wash water (FIGS. 2, 4 and 6). In addition, in all cases the CO2 treatment greatly reduced the acceleration caused by increases aging of the wash water (FIG. 2).

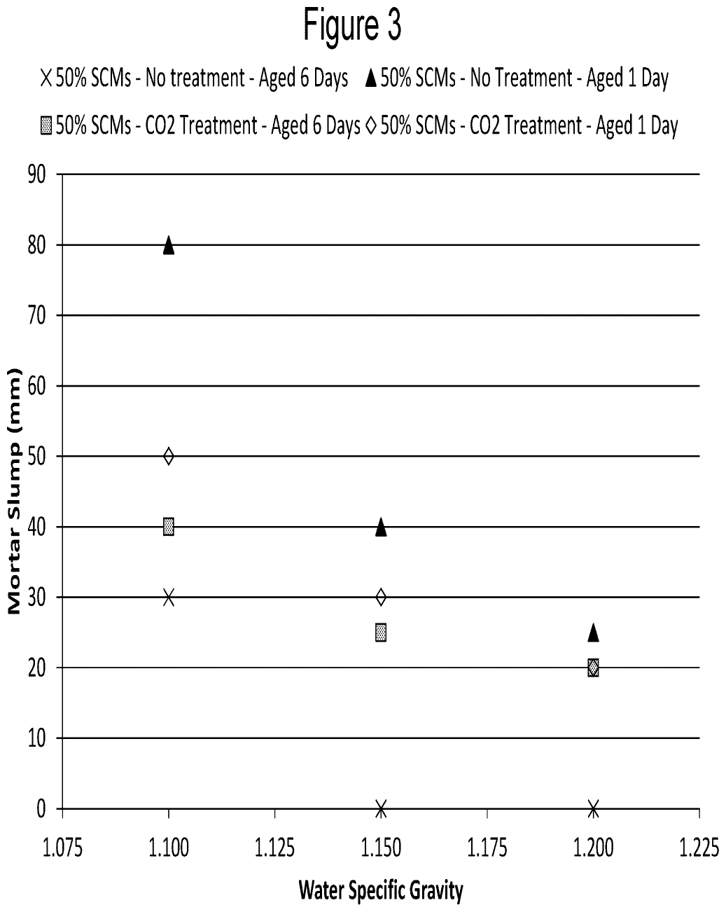

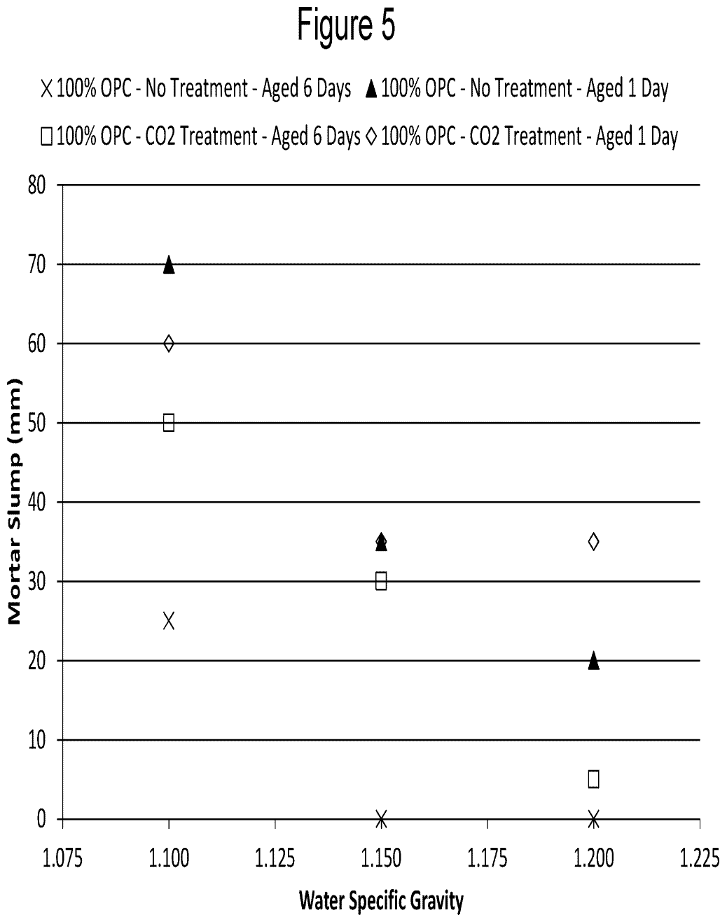

Workability. In all cases the CO2 treatment greatly reduced the loss of workability caused by increases aging of the wash water (FIGS. 3 and 5).

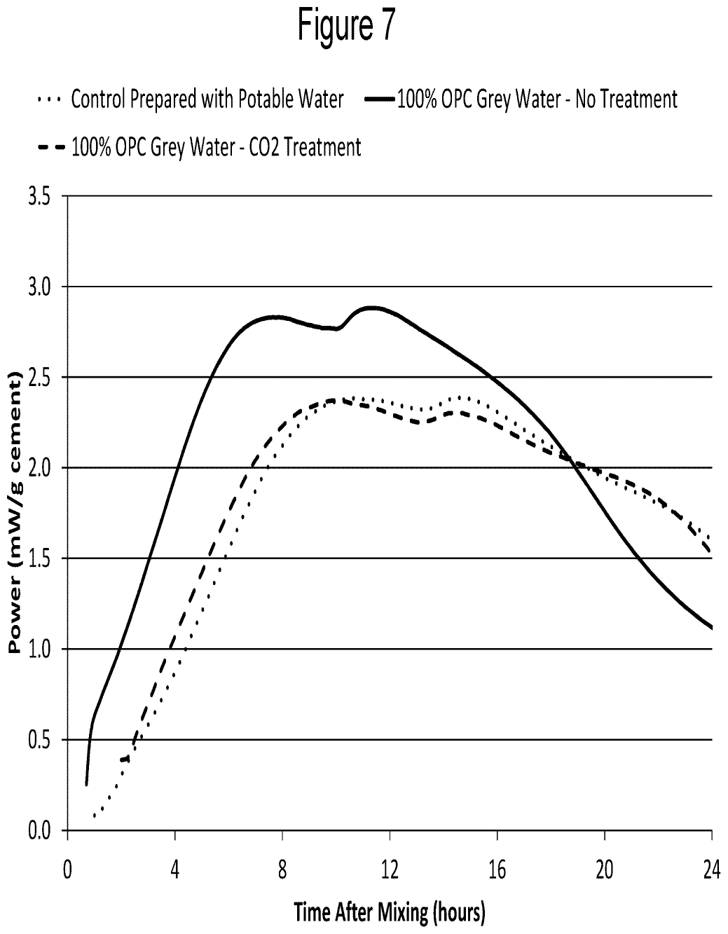

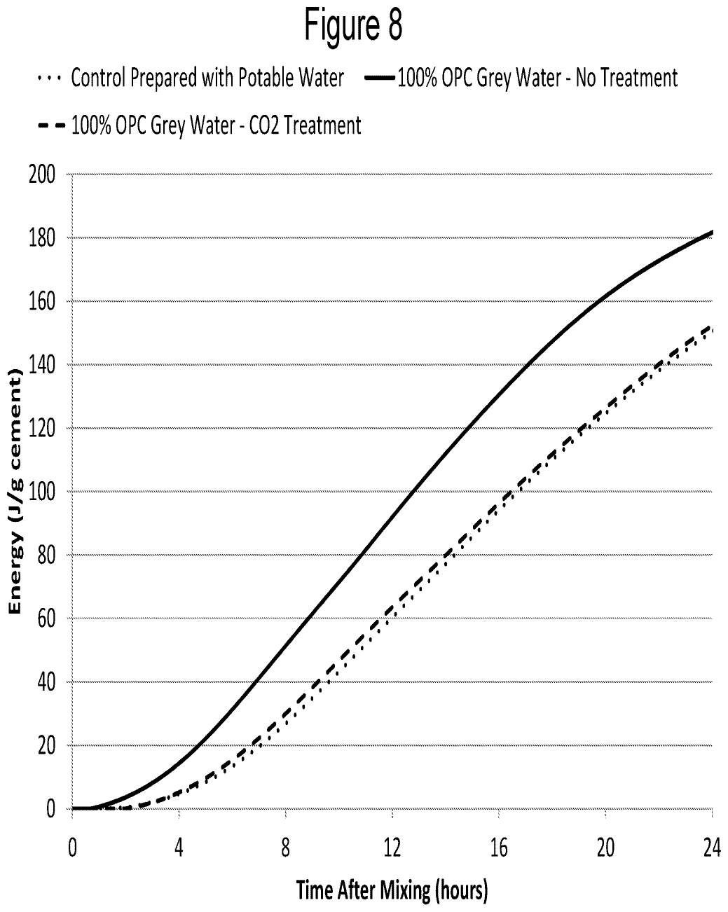

Calorimetry. The CO2 treatment has a marked impact on the hydration of cement in mortars prepared with grey water, returning the onset and intensity of features to the same region as the control sample made with potable water. FIGS. 7-8 are representative calorimetry curves as observed from the previously presented experiments. In all cases the grey water was prepared with 100% OPC to have a specific gravity of 1.1 and aged for 1 day. The curves presented compare the calorimetry response for three cases: 100% OPC grey water without CO2 treatment; 100% OPC grey water with CO2 treatment; a control produced with potable water. From both power (FIG. 7) and energy (FIG. 8) perspective it can be observed that the CO2 treatment allows the hydration of cement in the mortar samples to proceed normally: when using the CO2 treatment the onset and intensity of features is in-line with those observed for the control produced with potable water

### Carbon Dioxide Exposure Variables

In a second set of tests, three different modes of CO2 exposure were tested: Continuous—the grey water was exposed to CO2 starting at approximately 2 hours after mixing until use, Treatment at 2 hours—the grey water was exposed to CO2 once at approximately 2 hours after mixing and untreated until use as mix water; Treatment before use—the grey water was untreated until approximately 15 minutes before use. These three variations were meant to mimic timeframes when CO2 could foreseeably be applied to grey water in an industrial setting. The choice of 2 hours was meant to begin the CO2 treatment after the grey water had been prepared, but before any significant cement hydration had occurred. In practice this timeframe could be anywhere from 15-180 minutes.

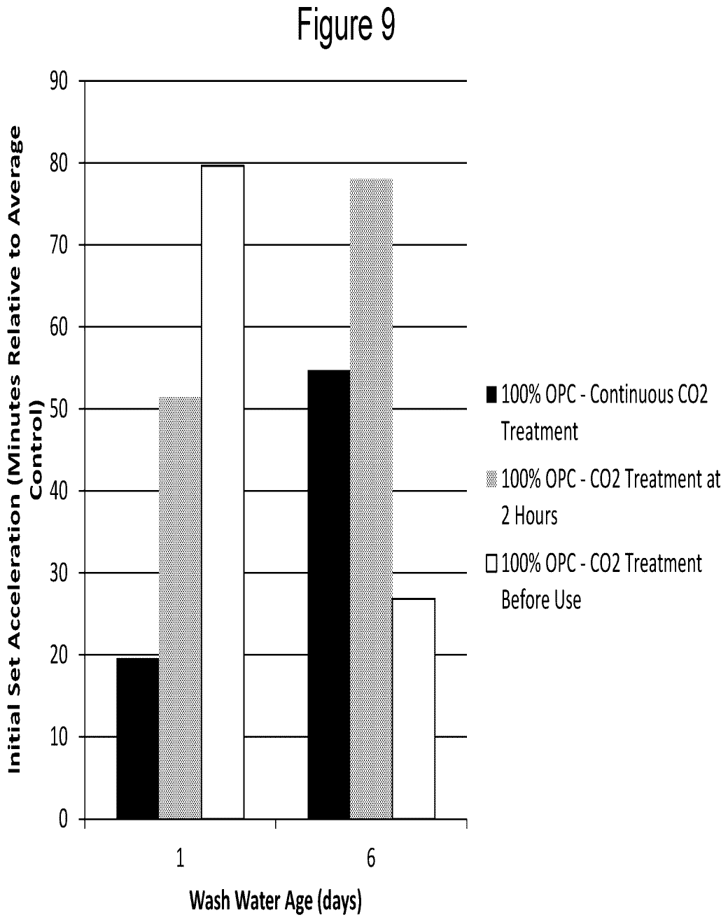

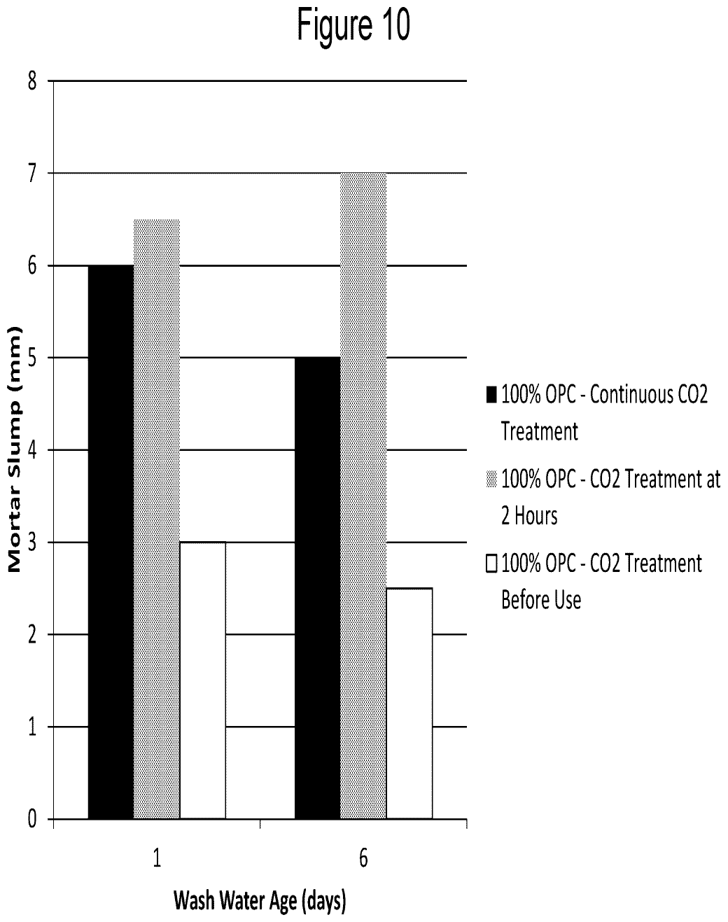

Continuous treatment offered the best improvement of set time after 1 day of aging while CO2 treatment before use offered the best improvement after 6 days of aging (FIG. 9). In general treatment at 2 hours provided the best slump impact (FIG. 10).

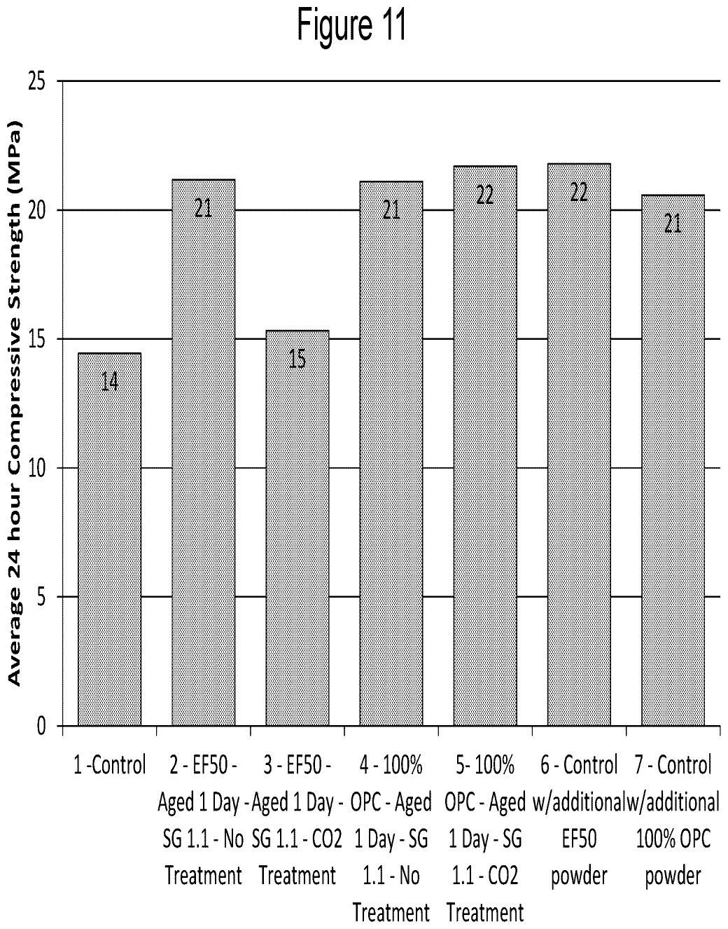

Strength Assessment. See FIG. 11

Sample of grey water were used to prepare 2″×2″×2″ mortar cubes for assessment of compressive strength development. All grey water was aged for 1 day and prepared at a specific gravity of 1.1. Compressive strength tests were performed at 24 hours after mixing. The samples were prepared as follows: A control made with potable water; EF50 grey water without CO2 treatment; EF50 grey water with CO2 treatment; 100% OPC grey water without CO2 treatment; 100% OPC grey water with CO2 treatment; Control with additional EF50 powder; Control with additional 100% OPC powder. Where the additional solids in the grey water are cementitious in nature samples 6 and 7 were prepared with the same amount of solids as in the grey water. In all cases this was introduced as additional anhydrous binder.

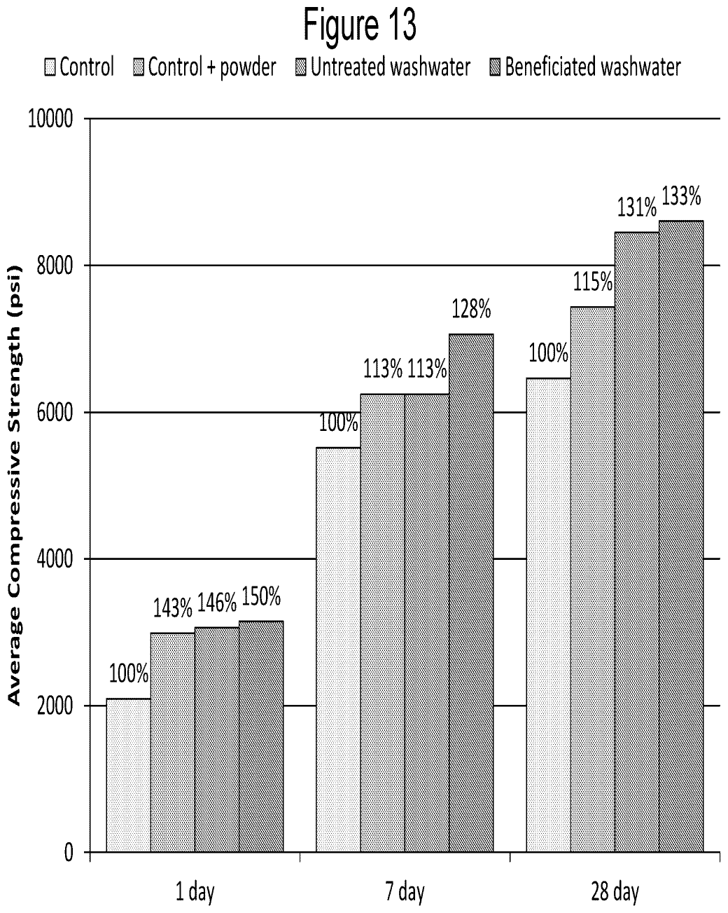

In all cases the samples performance was equivalent or better than a control produced with potable water (FIG. 11). There was also a strength enhancement at later time points, for example, 7 and/or 28 days. See FIGS. 13 (Washwater of 100% OPC, SG 1.1) and 14 (Washwater 50% cement, 30% slag, 20% class F fly ash).

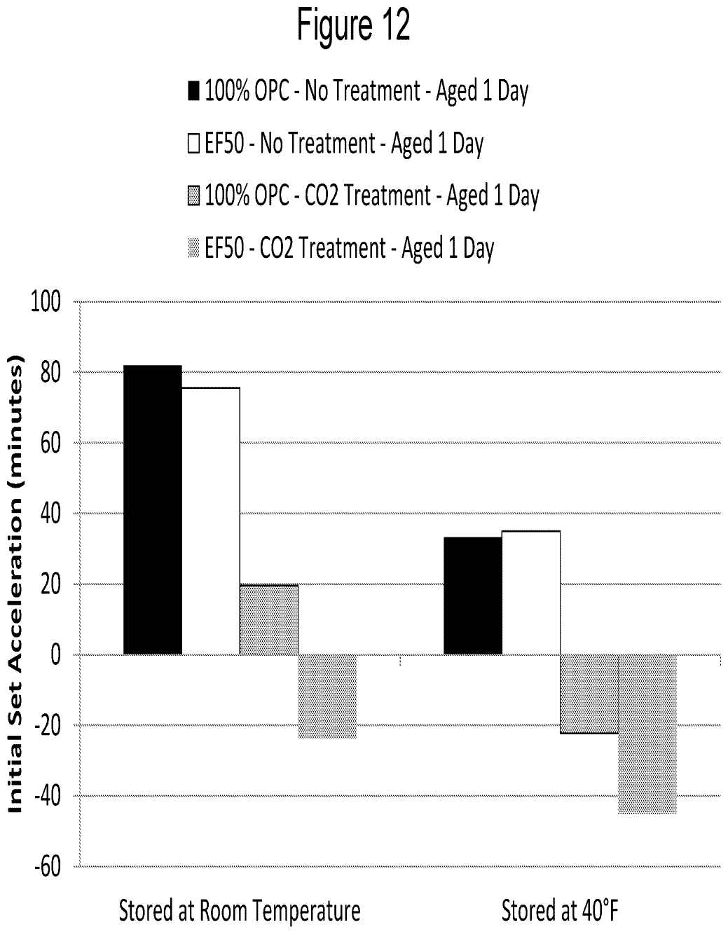

Cooling. Samples of grey water with two different compositions (EF50 and 100% OPC) were prepared at a specific gravity of 1.1 and stored at one of two temperatures: Low temperature=40° F.; Room temperature=approximately 65° F. A combination of cooling and CO2 treatment provided a synergistic improvement in mortar set time, see FIG. 12.

### Example 3

Binder powder was added to samples of water and allowed to age either 1 or 7 days. The binder powder for a given water sample matched the composition of the binder for the mortar later produced from the water; e.g., if the mortar were to be made with 100% OPC, binder powder for wash water was 100% OPC; if the mortar were to be made with 75/25 OPC/class F fly ash, a 75/25 OPC/class F fly ash was used. Water was either left untreated, or treated with CO2 consistently over the aging period. An excess of CO₂ was supplied to allow thorough carbonation. Following aging of the mix water mortar samples were prepared according to the following recipe: 1350g EN Sand, 535g cement. Set time was measured from calorimetry as the thermal indicator of set (the hydration time to reach a thermal power of 50% of the maximum value of the main hydration peak, ASTM C1679).

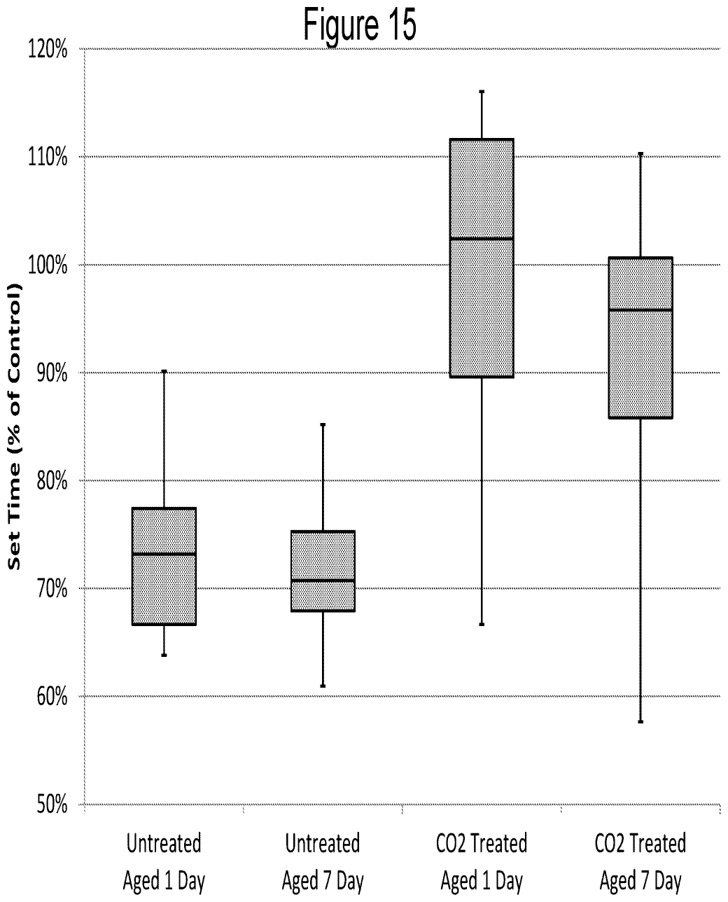

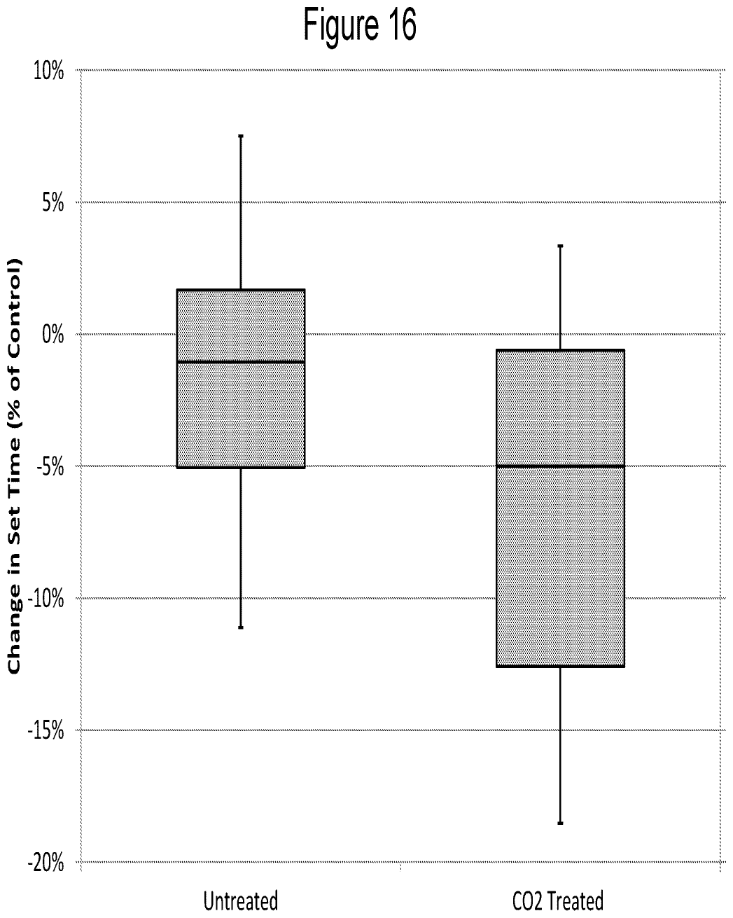

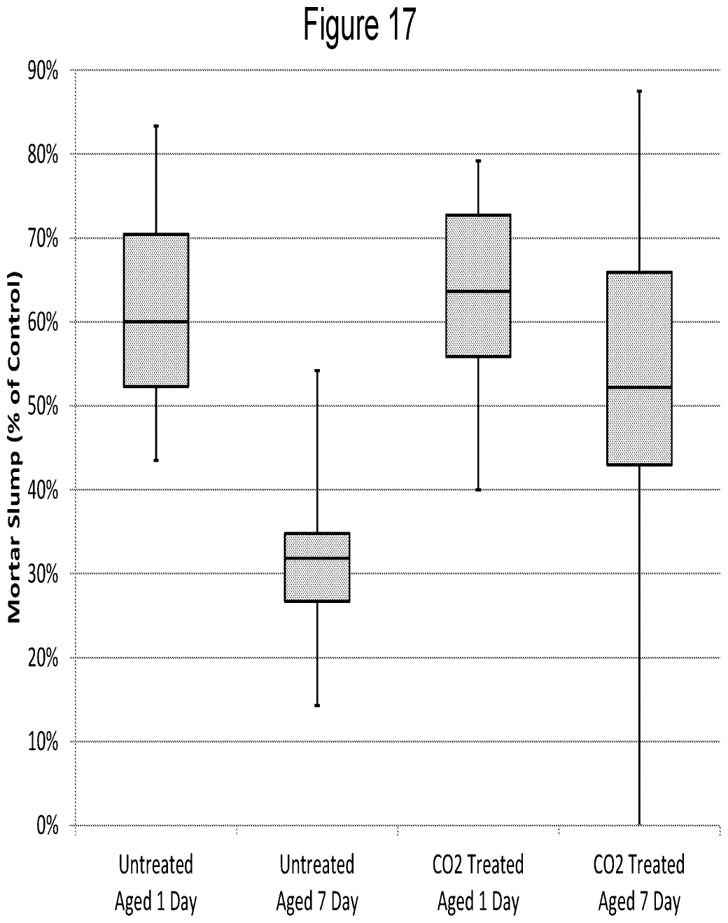

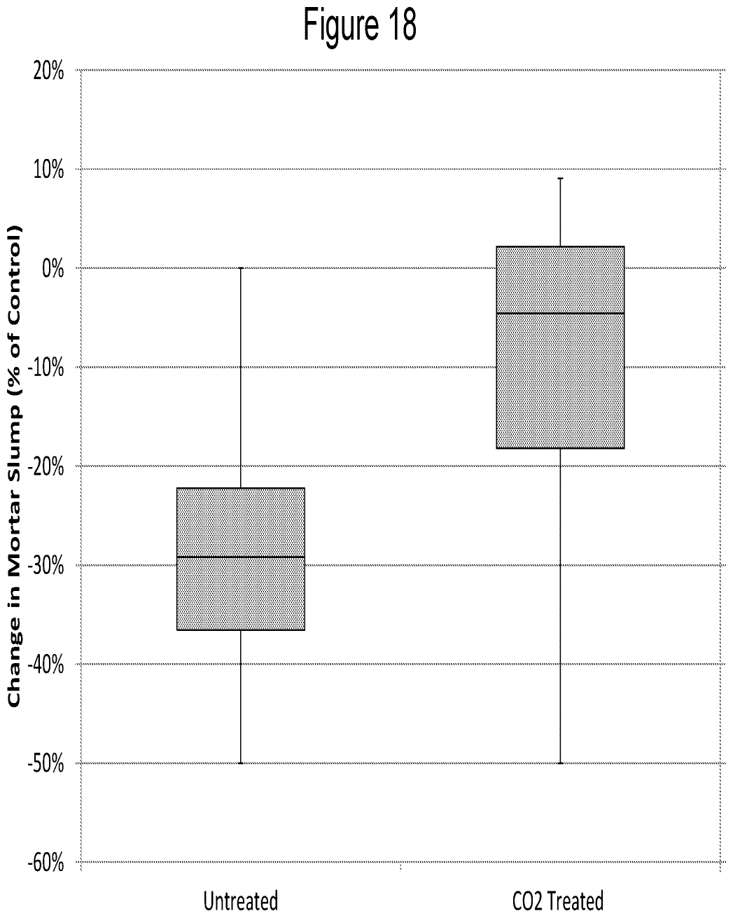

The results are shown in FIGS. 15-18 and TABLE 2. 15 different batches were aggregated for each condition, and results are shown as BOX PLOTS showing 1^{st} quartile, median, and 3^{rd} quartile. Whiskers show max and min. FIG. 15 shows set time relative to a potable water control with the same binder composition and w/b. Set time is reduced in untreated water (average 73% to 71%). Set time is improved to neutral if CO2 treatment is used (Average is 98% at 1 day, 91% at 7 days). FIG. 16 shows set time at 7 days relative to set time at 1 day. Water aging did not have a large effect on set time for either case (decline in average by 2% for untreated and 6% in CO2 treated water). FIG. 17 shows mortar slump (workability) relative to a potable water control with the same binder composition and w/b. Slump was compromised when using wash water, and became worse with age if the water was not treated. The average declined from 62% to 32% in the untreated water, and 63% to 51% in the treated water; thus, carbon dioxide treatment mitigated the further decrease in slump in aging wash water compared to untreated. FIG. 18 shows mortar slump at 7 days relative to mortar slump at 1 day. Workability was worse for 7 day wash water than 1 day was water if it is untreated, but, as noted, there was small to no change observed if CO2 treatment was applied. The results are also summarized in TABLE 2.

TABLE 2
Effect of CO2 treatment of wash water on set time and workability

| Slump Summary vs Potable | | | | | | |
|---|---|---|---|---|---|---|
| Water Reference | | | | | | |
| | | | CO2 | CO2 | Relative Change | |
| | Untreated | Untreated | Treated | Treated | in Slump | |
| | Aged | Aged | Aged 1 | Aged 7 | | CO2 |
| Metric | 1 Day | 7 Days | Day | Days | Untreated | Treated |
| Average | 62% | 32% | 63% | 51% | −29% | −11% |
| Median | 60% | 32% | 64% | 52% | −29% | −5% |
| Min | 43% | 14% | 40% | 0% | −50% | −50% |
| Max | 83% | 54% | 79% | 88% | 0% | 9% |
| 1st | 52% | 27% | 56% | 43% | −37% | −18% |
| Quartile | | | | | | |
| 3rd | 70% | 35% | 73% | 66% | −22% | 2% |
| Quartile | | | | | | |
| | Set Time Summary vs Potable | | | | | |
| | Water Reference | | | | | |
| | | | CO2 | CO2 | Relative Change | |
| | Untreated | Untreated | Treated | Treated | in Set Time | |
| | Aged | Aged | Aged 1 | Aged 7 | | CO2 |
| Metric | 1 Day | 7 Days | Day | Days | Untreated | Treated |
| Average | 73% | 71% | 98% | 91% | −2% | −6% |
| Median | 73% | 71% | 102% | 96% | −1% | −5% |
| Min | 64% | 61% | 67% | 58% | −11% | −19% |
| Max | 90% | 85% | 116% | 110% | 8% | 3% |
| 1st | 67% | 68% | 90% | 86% | −5% | −13% |
| Quartile | | | | | | |
| 3rd | 77% | 75% | 112% | 101% | 2% | −1% |
| Quartile | | | | | | |

### Example 4

This Example describes the effects of duration of exposure of wash water to carbon dioxide.

Binder powder was added to samples of water to create simulated wash water at specific gravity of 1.1. The water samples were mixed for varying durations, starting about 30 minutes after they were first produced. The water was either left untreated, or treated with CO₂ consistently over the mixing period. An excess of CO₂ was supplied to allow thorough carbonation. The pH of the water and CO₂ uptake of the solids was measured. Water samples were allowed to age either 1 or 7 days. Following aging of the mix water mortar samples were prepared according to the standard recipe. 1350g EN Sand, 535g cement.

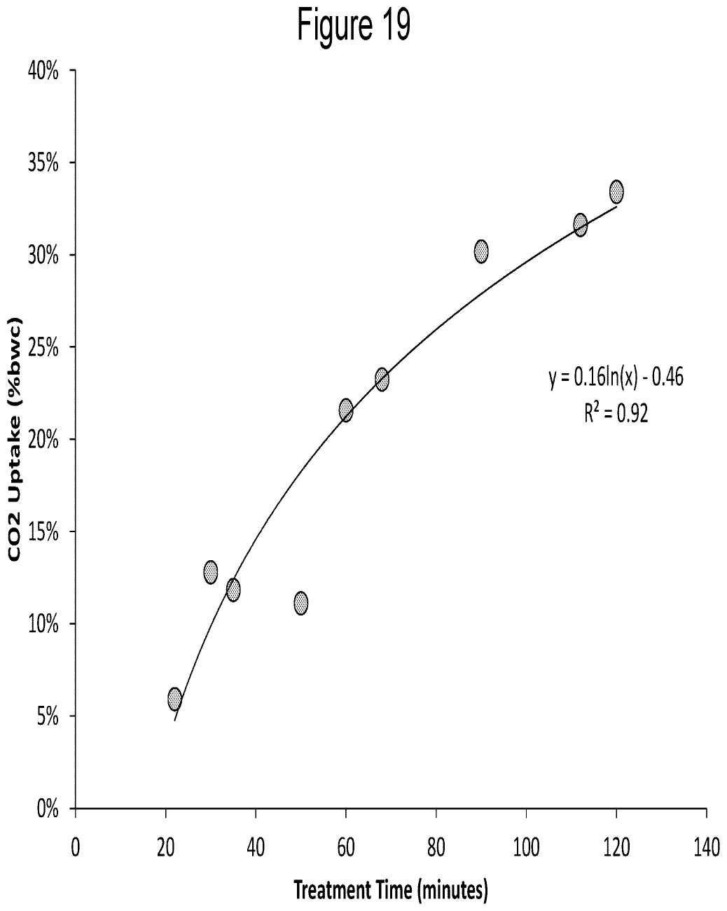

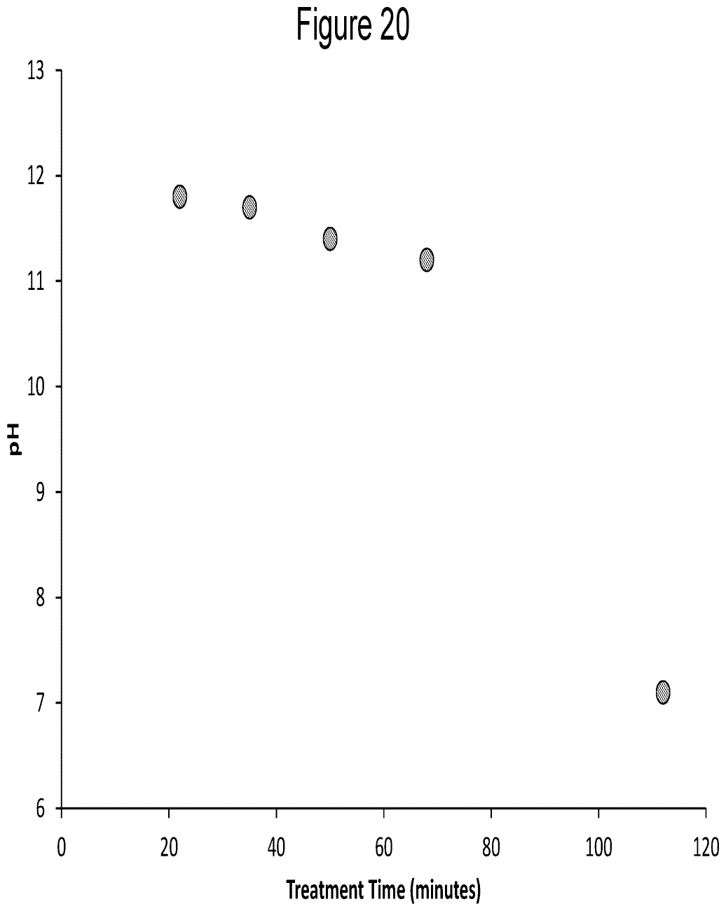

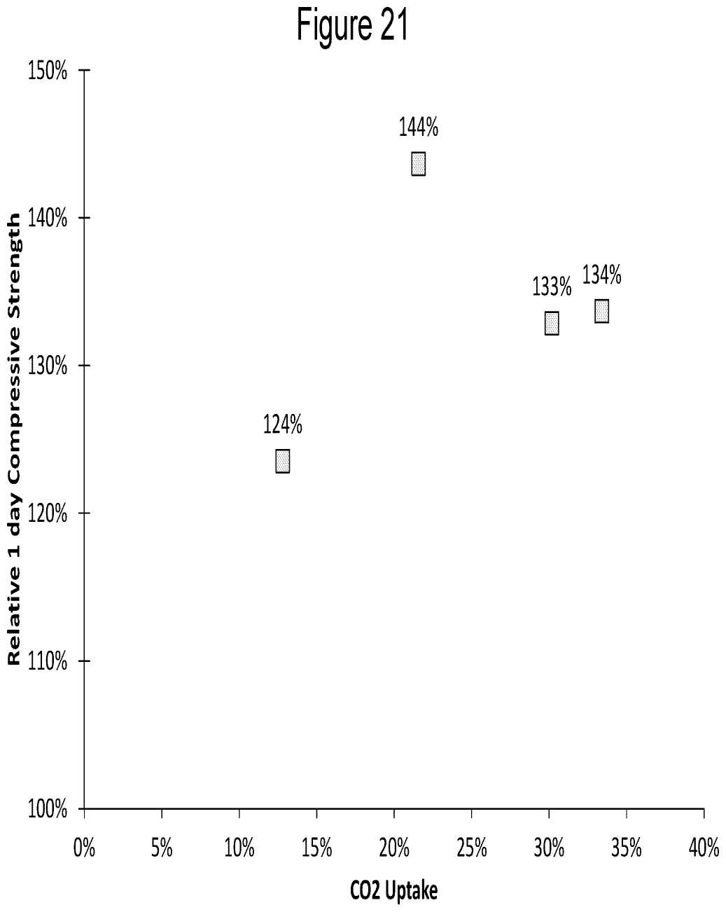

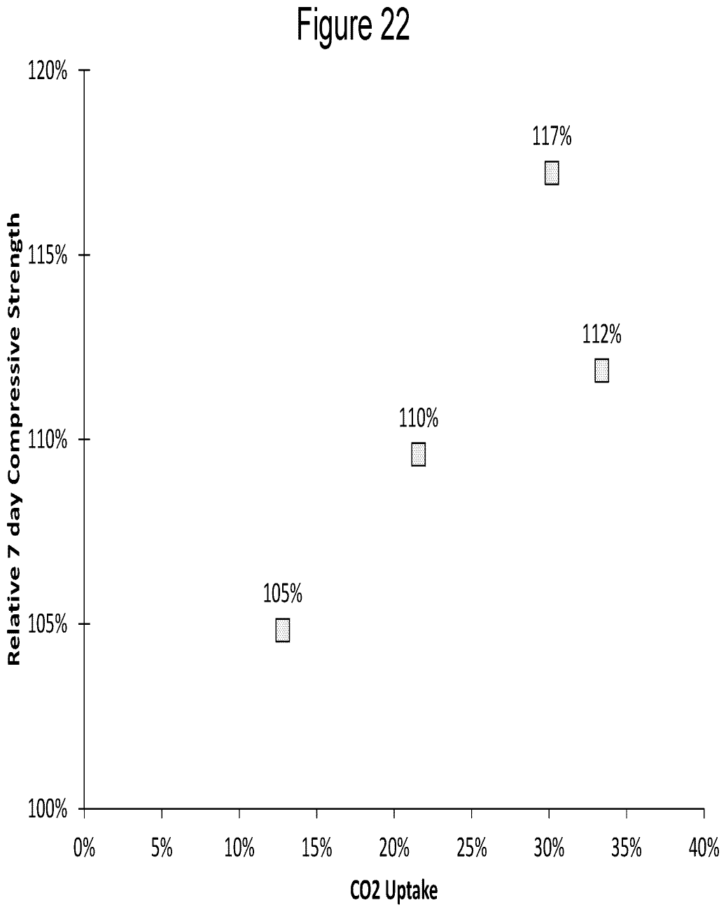

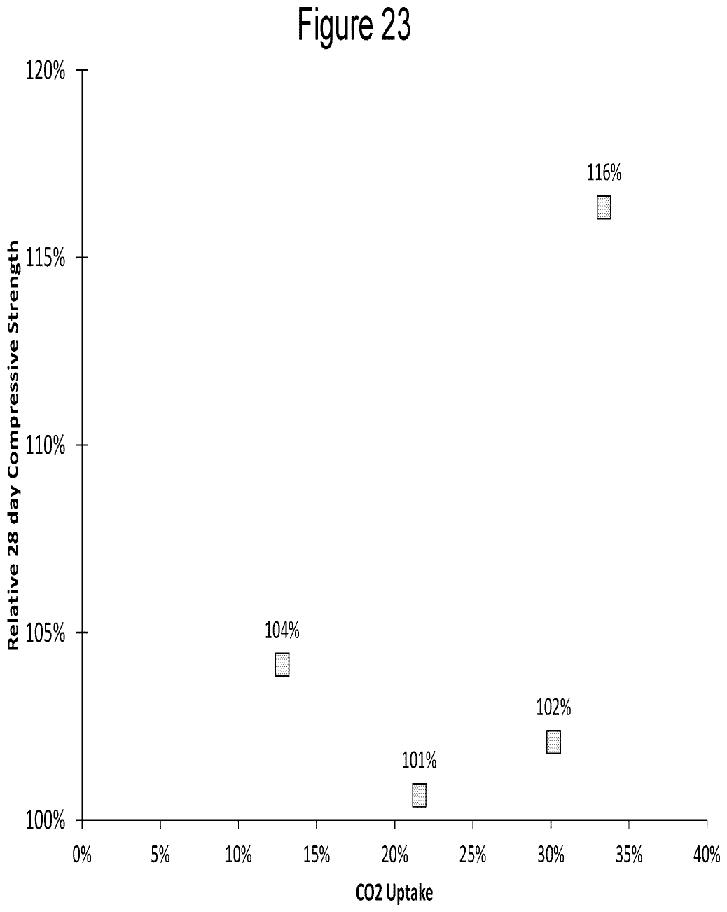

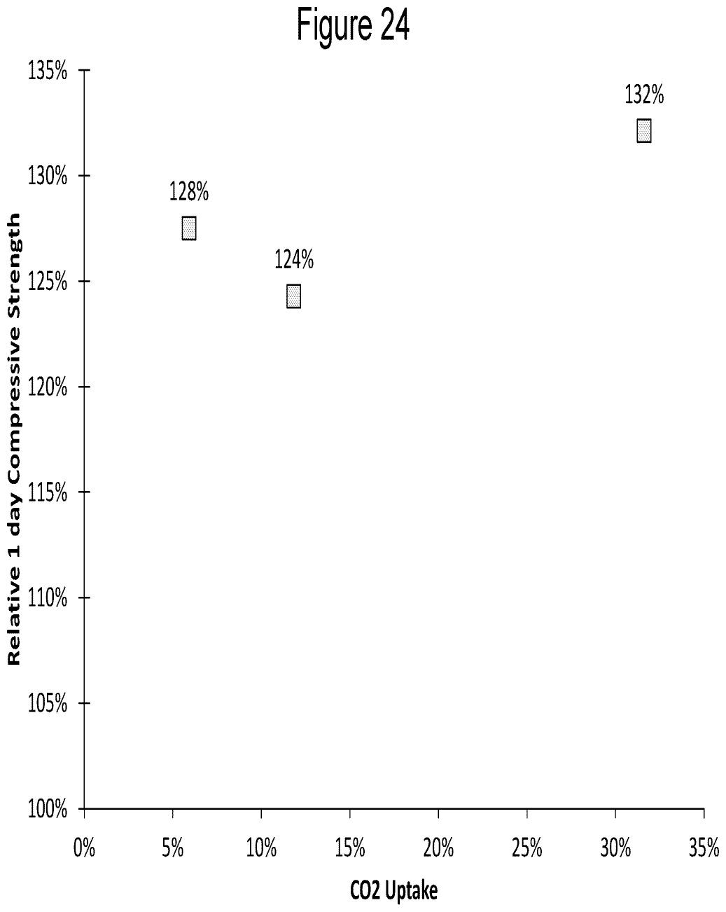

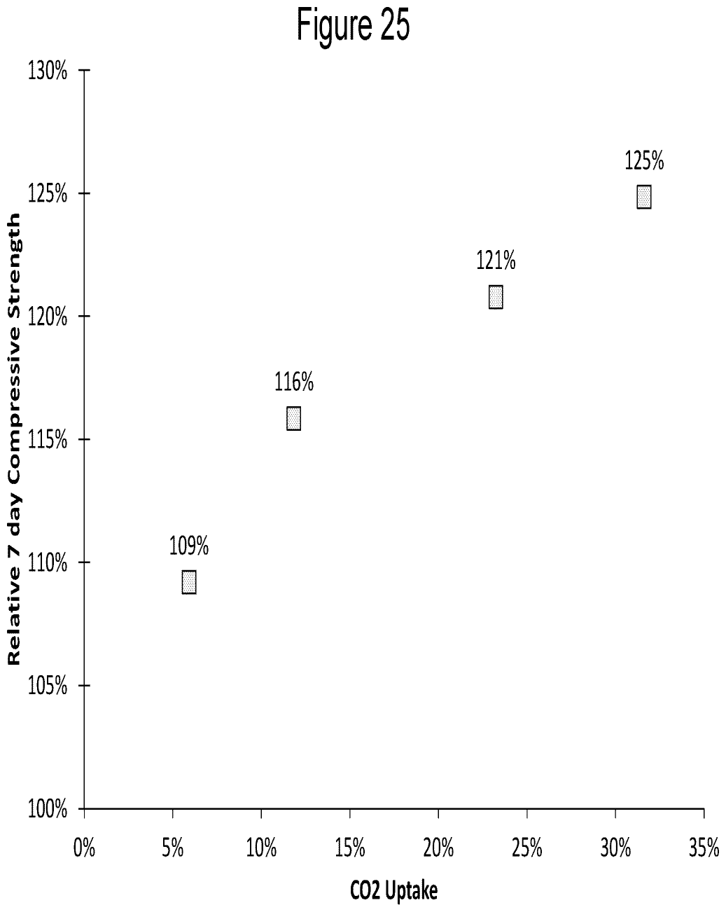

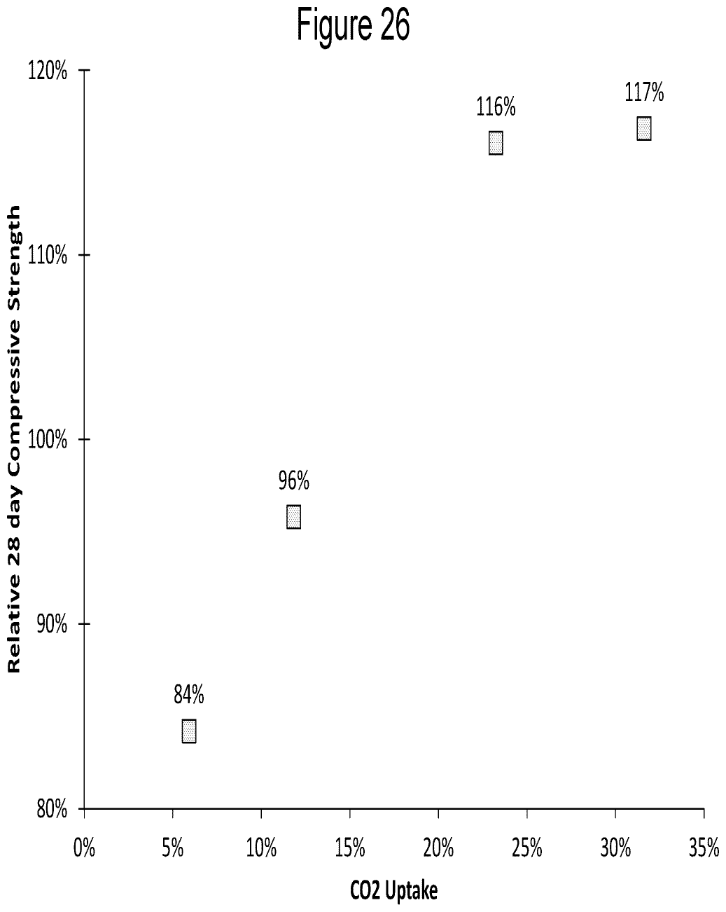

As expected, CO2 uptake of wash water solids increased with treatment time (FIG. 19), with a corresponding decrease in the pH of the wash water (FIG. 20). One-day (FIG. 21), 7-day (FIGS. 22), and 28-day strength (FIG. 23) were all increased in mortar cubes made with wash water aged 1 day that had been treated with carbon dioxide compared to cubes made with untreated wash water. One-day (FIGS. 24) and 7-day strength (FIG. 25) were increased in mortar cubes made with wash water aged 7 days that had been treated with carbon dioxide compared to cubes made with untreated wash water: 28-day strength decreased for cubes made with wash water with lower carbon dioxide uptake but increased for those made with wash water with higher carbon dioxide uptake (FIG. 26).

### Example 5

Cemex Demopolis cement was used as wash water solids (100% cement), added to potable water until specific gravity 1.10, then aged 1 or 7 days, with and without CO2 treatment. Control mortar cubes were produced using potable water, reference cubes were produced using potable water and additional cement equivalent to the solids contained within the wash water.

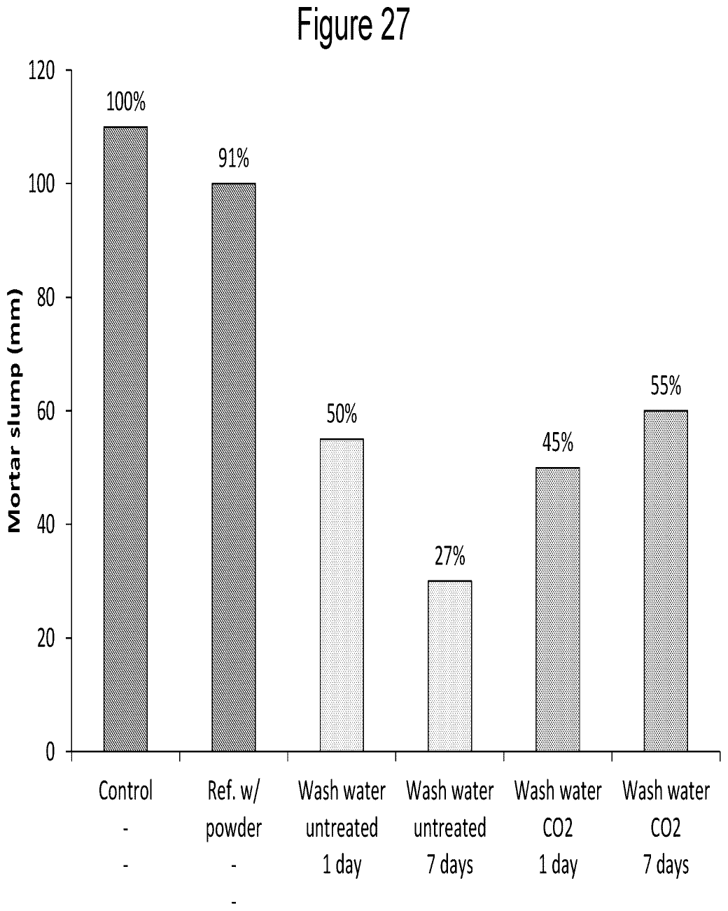

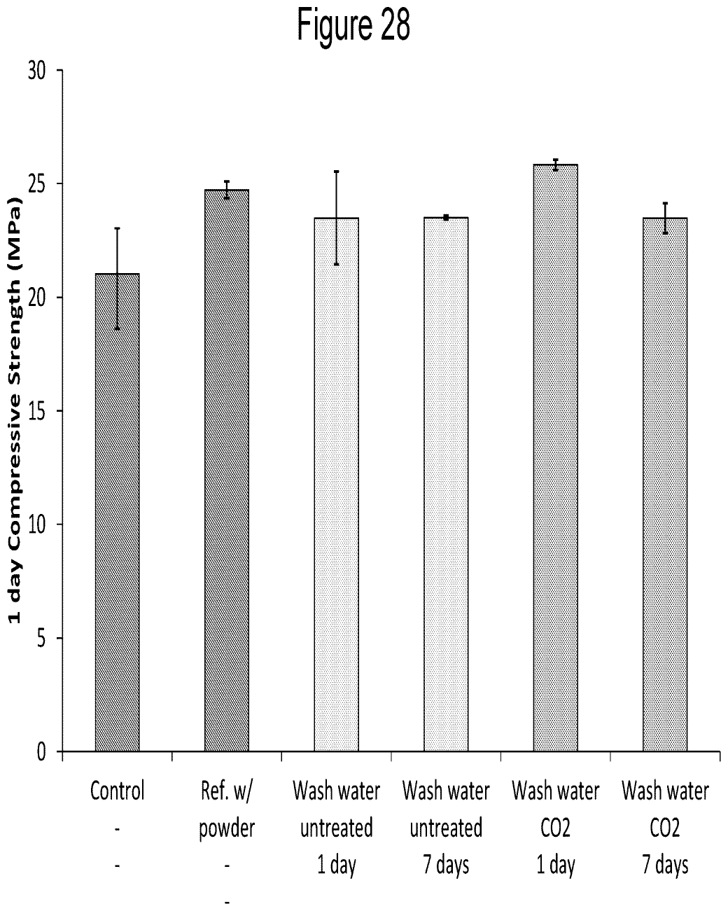

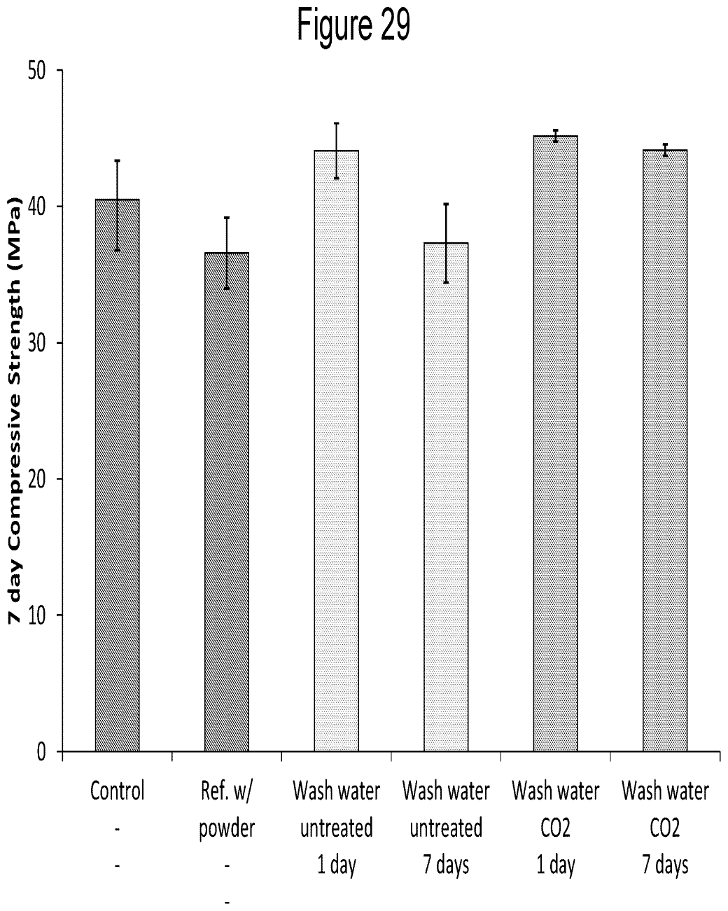

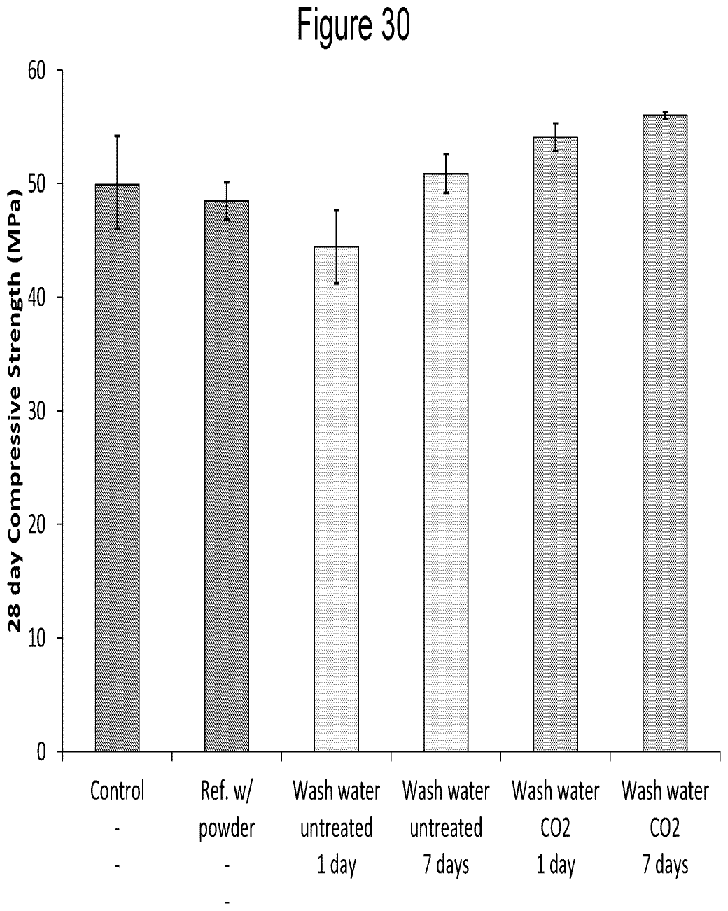

FIG. 27 shows that adding more cement to the control reduced the workability (slump). If that same amount of cement was present in one day old wash water the workability was reduced by about 50%. If the wash water was untreated and used at 7 days aging then the workability decreased further, but if treated with CO2 the performance at 7 days aging was no worse than at 1 day. FIGS. 28-30 show 1- , 7- , and 28-day compressive strengths for mortar cubes made with the wash waters. In sum, in 5 of 6 comparisons (two of the one day wash water samples and all three of the 7 day wash water samples) mortar the wash water treated with CO2 was stronger than a mortar made with an equivalent amount of extra cement. Samples made with CO2 treated wash water were equivalent or better strength than those with the untreated wash water at any sample age and any wash water age.

### Example 6

Lab wash water samples were produced through additions of neat cement and slag into potable water. After aging for 1 or 7 days the solids and liquids were separated via suction filtration for further analysis Solids were rinsed with isopropyl alcohol to remove any residual water and allowed to dry. Dried solids were submitted for analysis via X-ray diffraction (XRD), nuclear magnetic resonance (NMR) and scanning electron microscopy (SEM). Filtrate was passed through a 0.20 μm filter and submitted for chemical analysis via ICP-OES.

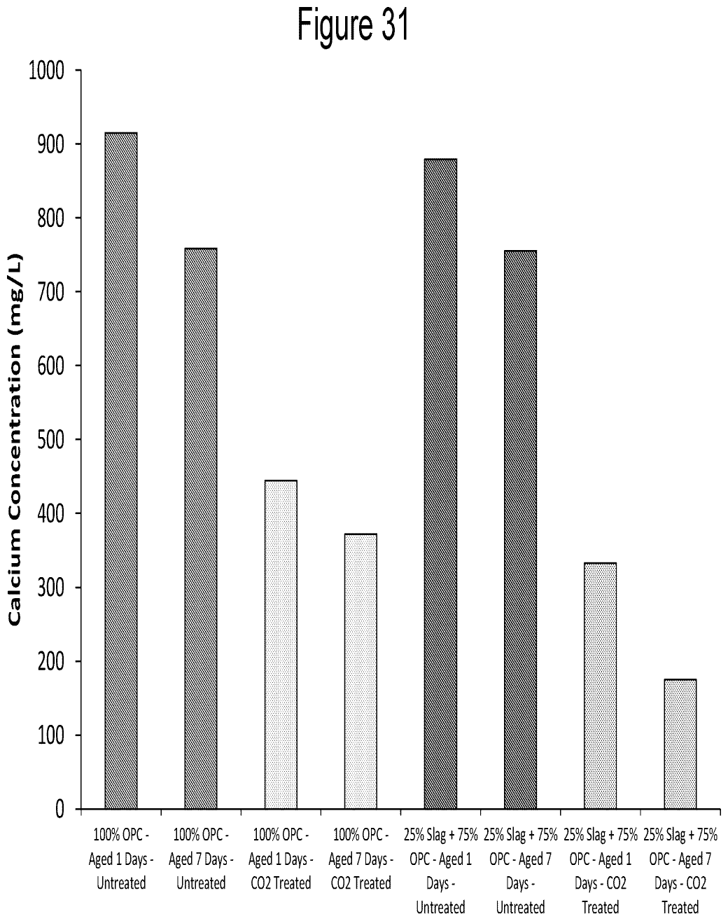

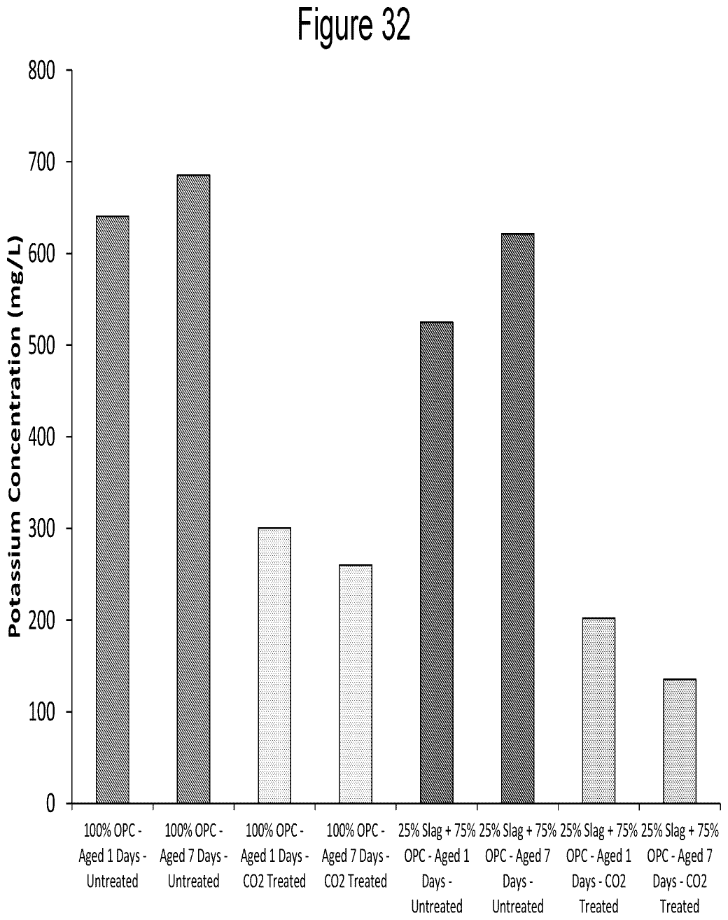

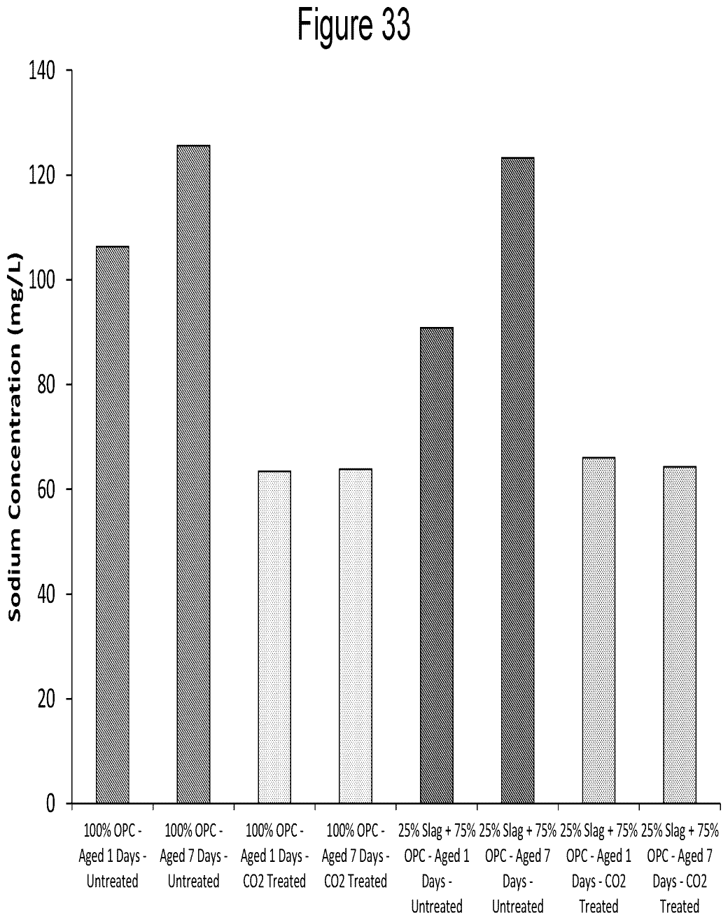

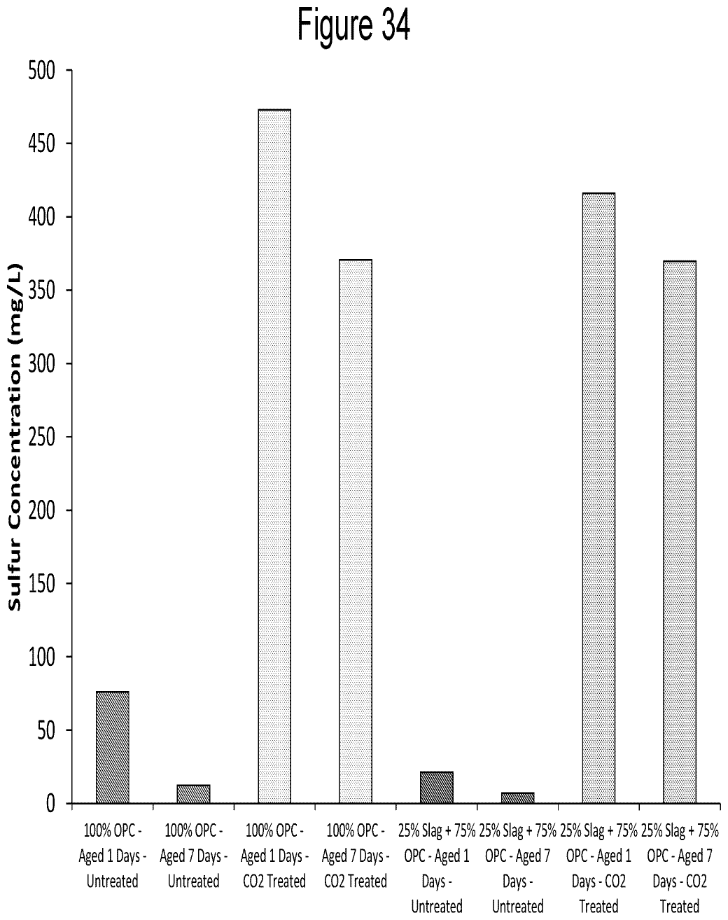

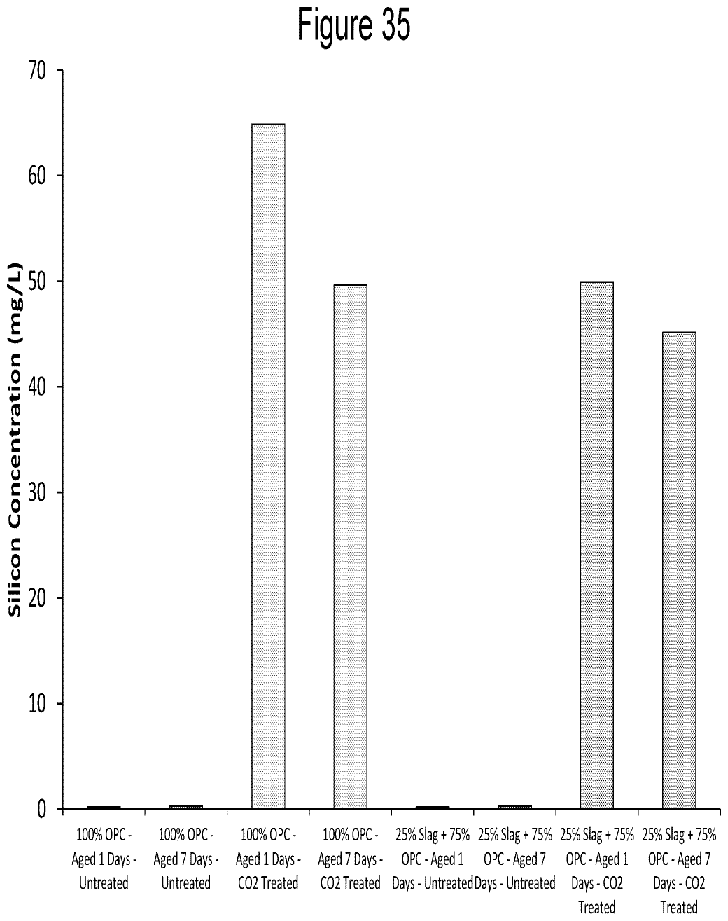

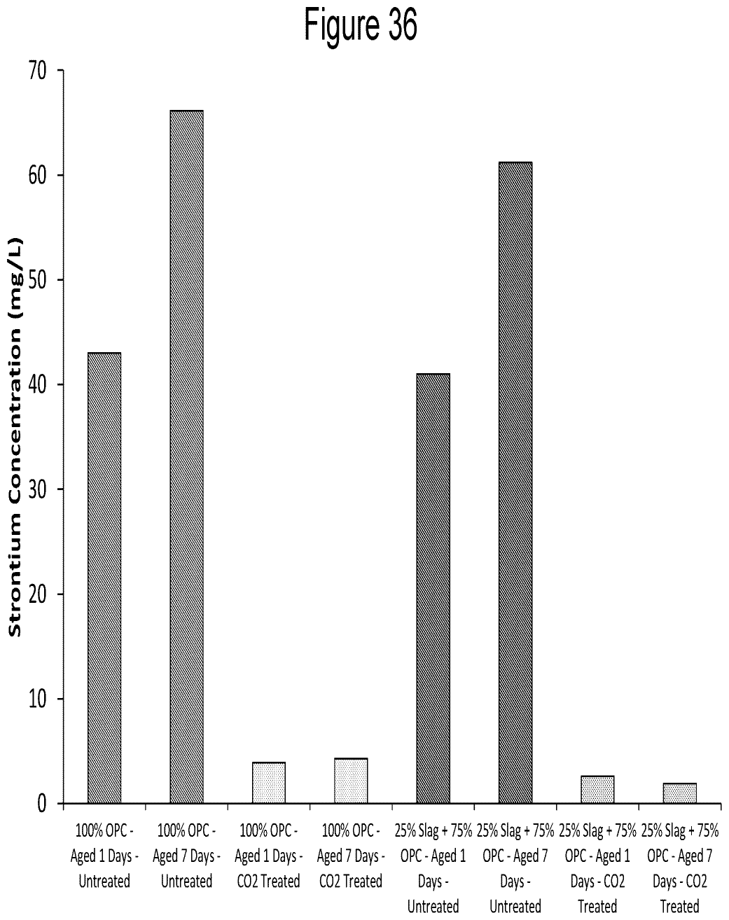

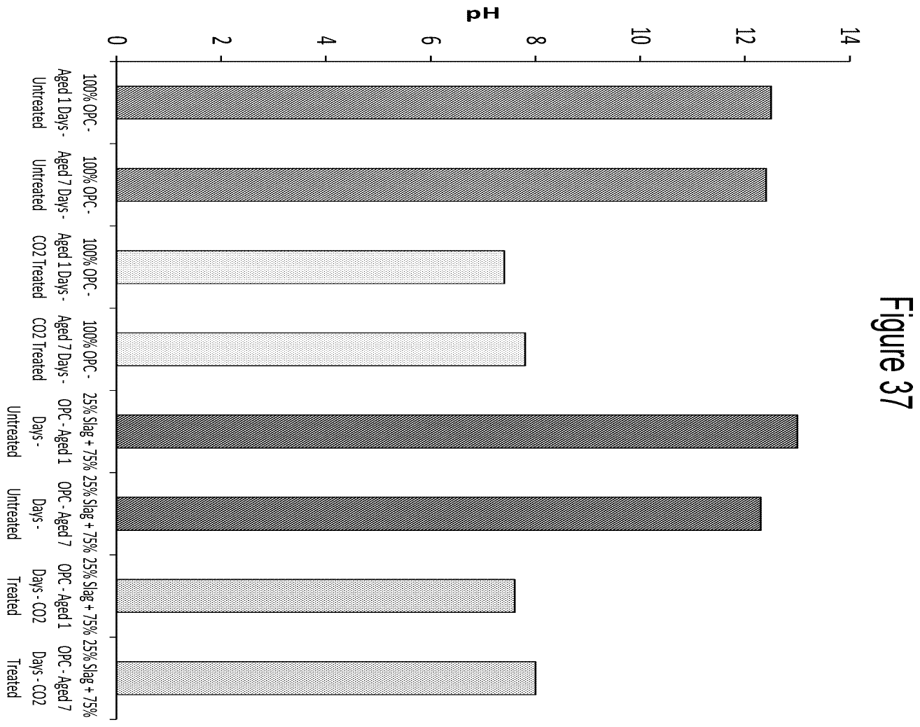

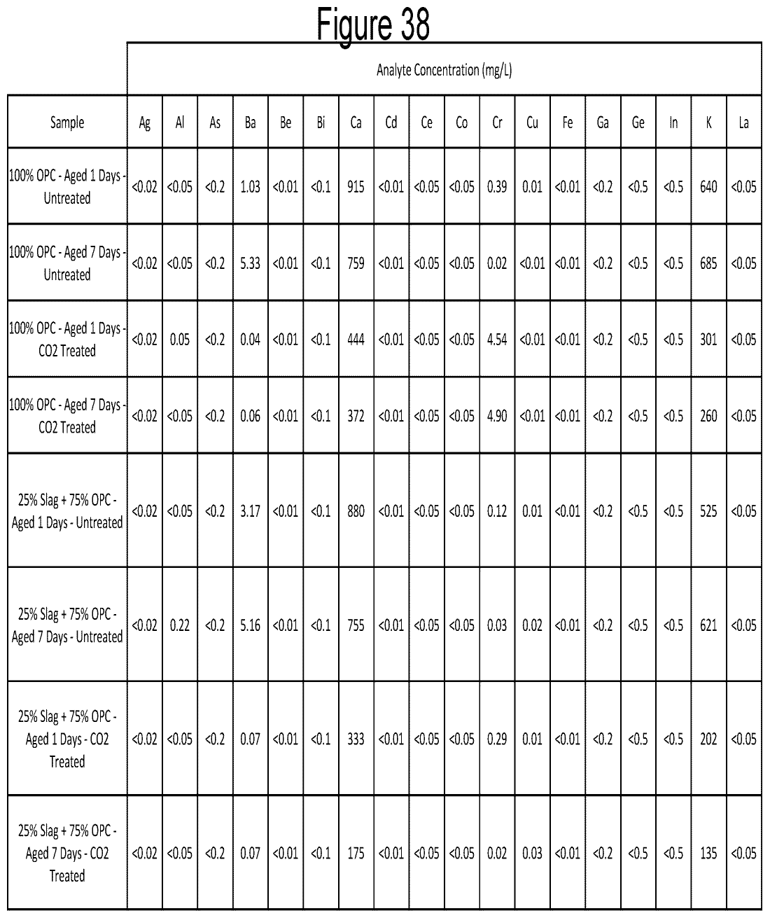

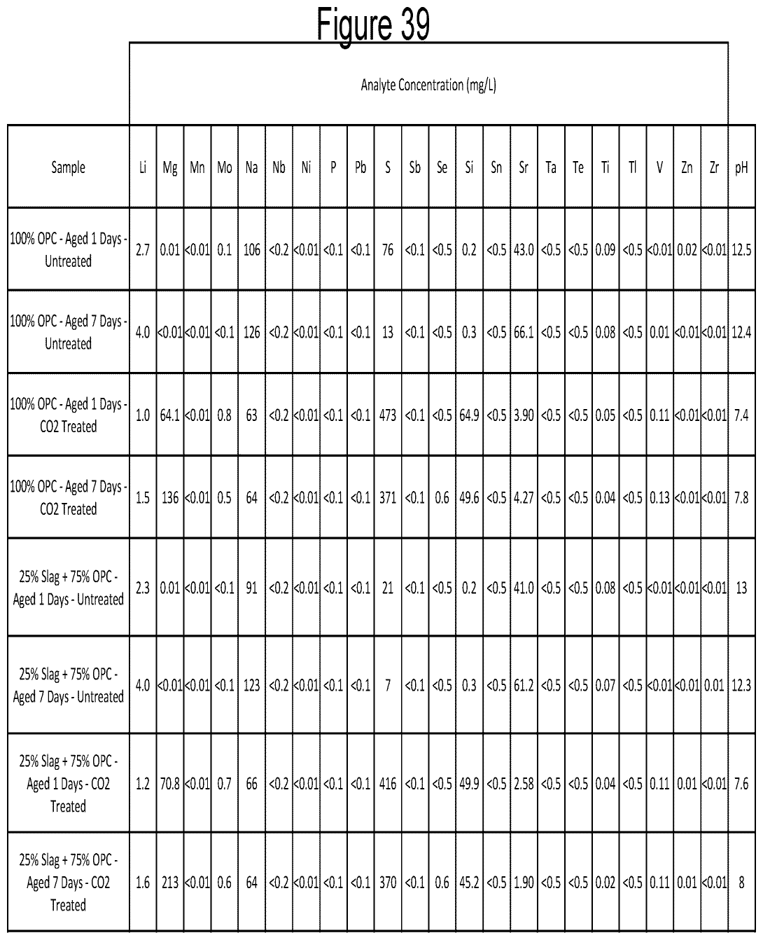

ICP-OES Analysis of filtrate passing 0.20 μm filter shows distinct changes in ions concentrations depending on the water treatment. The following ions were found to be present in lower concentrations following CO₂ treatment of the lab-produced wash water: Calcium, Potassium, Sodium, Strontium (FIGS. 31-34). The following ions were found to be present in greater concentrations following CO₂ treatment of the lab-produced wash water: Sulfur, Silicon (FIGS. 35 and 36). The CO₂ treatment was found to decrease the pH of wash water filtrate (FIG. 37). Data are shown in tabular form in FIGS. 38 and 39.

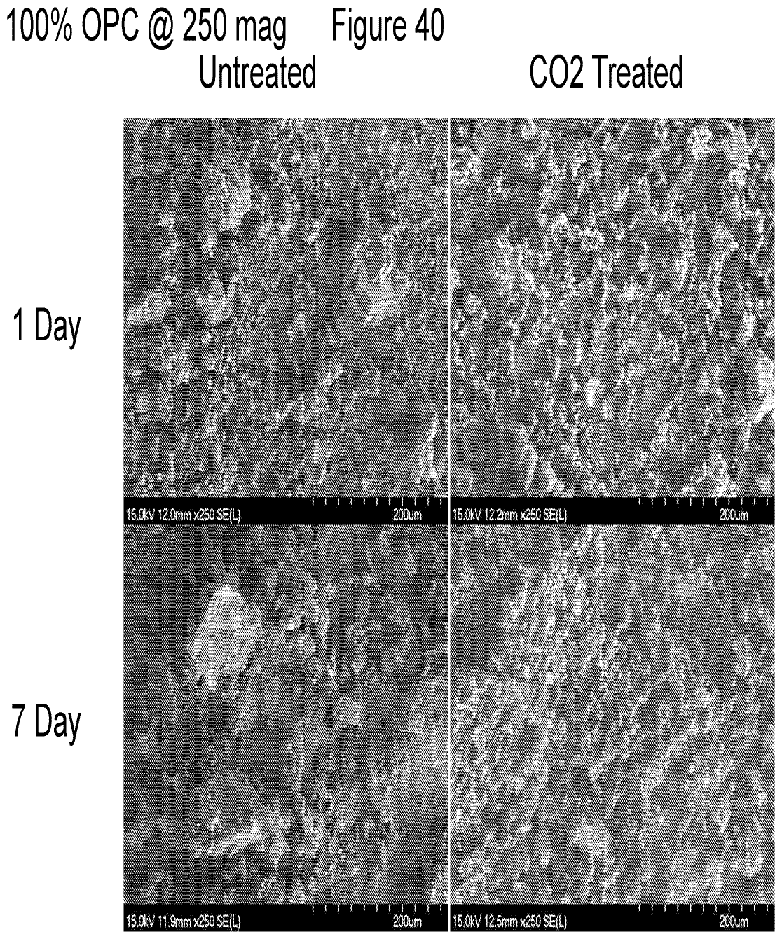

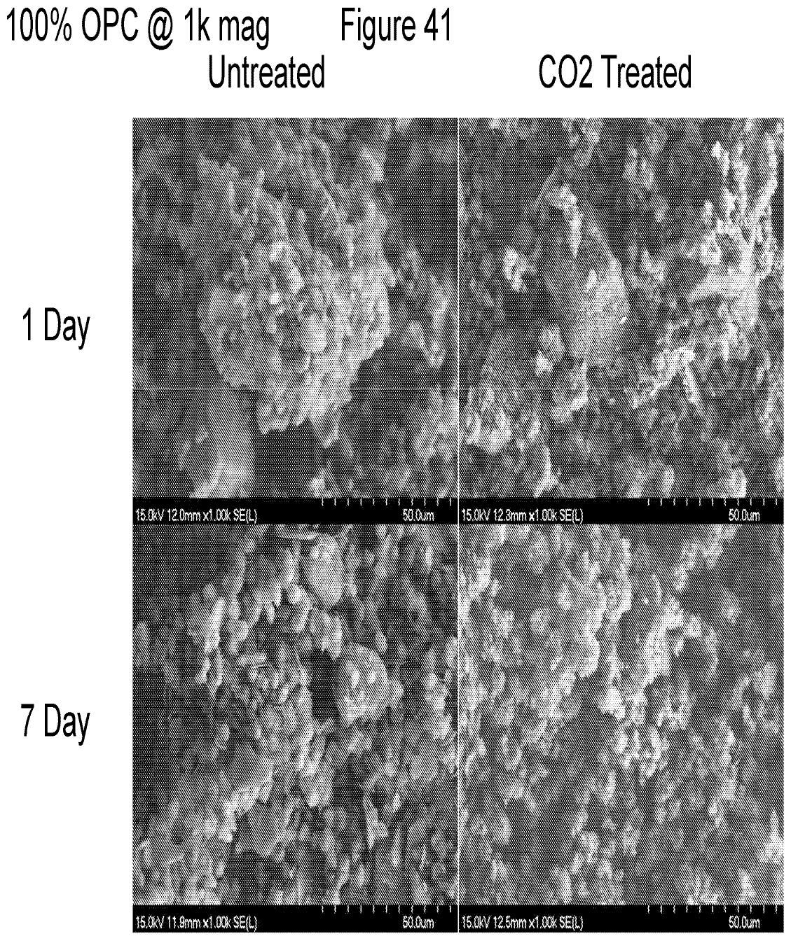

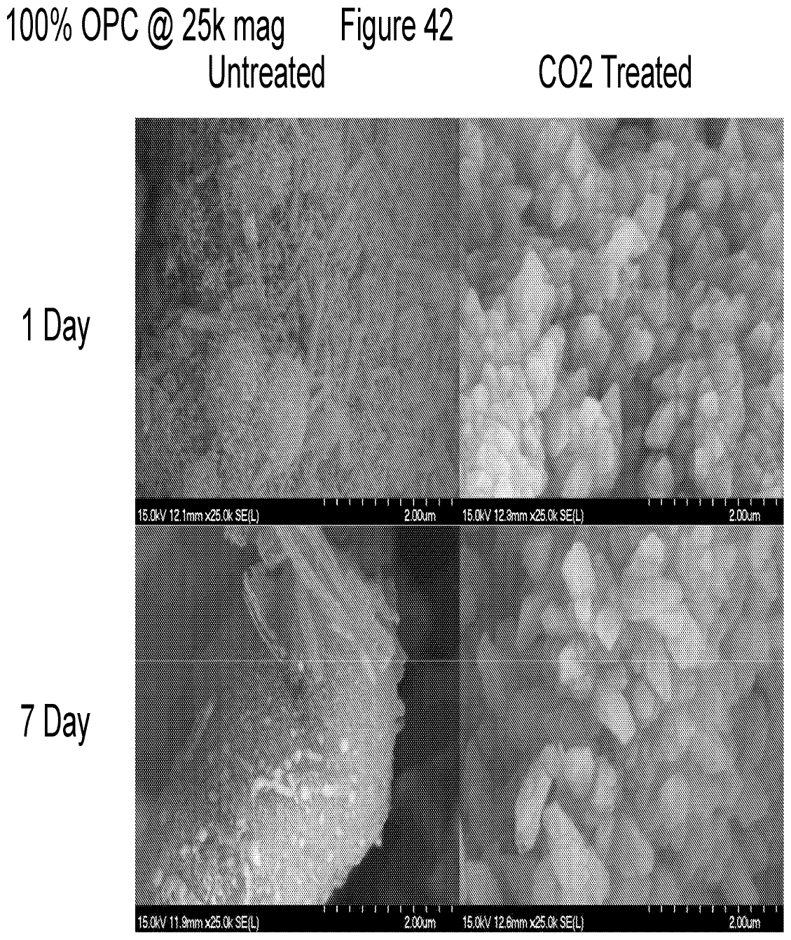

SEM. For 100% OPC wash water, at 250 magnification (FIG. 40): Hexagonal particles in untreated cases characteristic of portlandite. At 1000 magnification (FIG. 41): Untreated WW: Observe needle morphology at 1 days and presence of at 7 days suggests ongoing precipitation and growth of hydration products. At 25,000 magnification (FIG. 42): Untreated WW: mixture of fuzzy and needle-like hydration products characteristic of normal cement hydration. Features mature and become larger by 7-days, hence less detail at 25k magnification in 7-day versus 1-day. CO2 Treated WW: Abundance of small box-like products characteristic of calcite observable at 25 k mag. Microstructure of CO2 treated case appears generally the same between 1 and 7 days of aging.

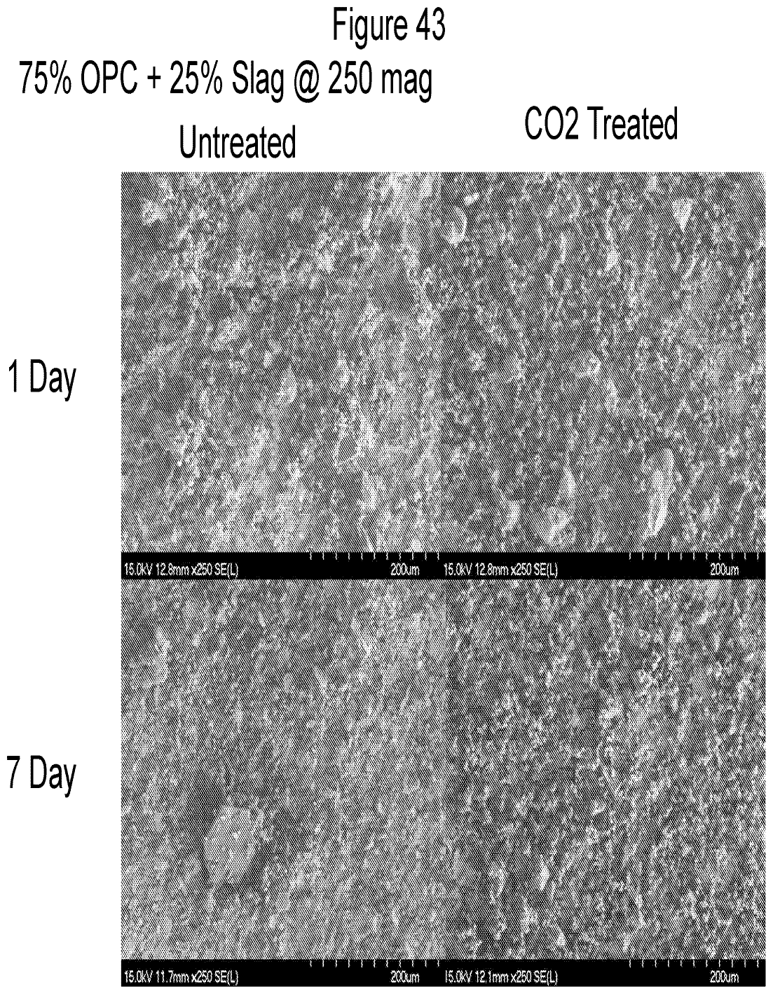

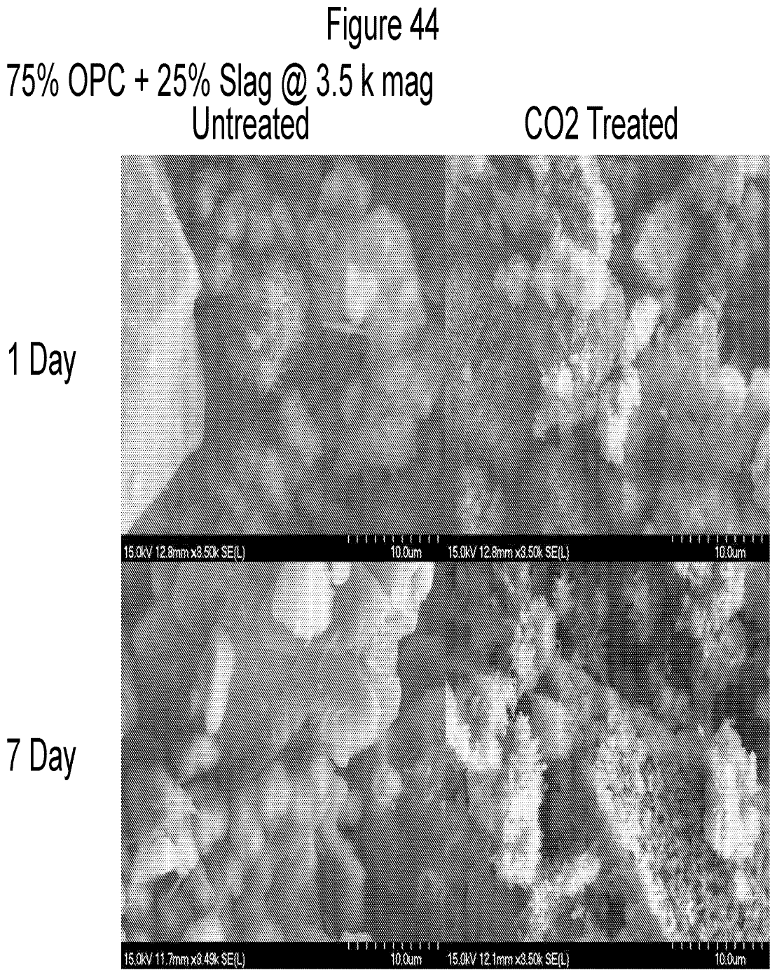

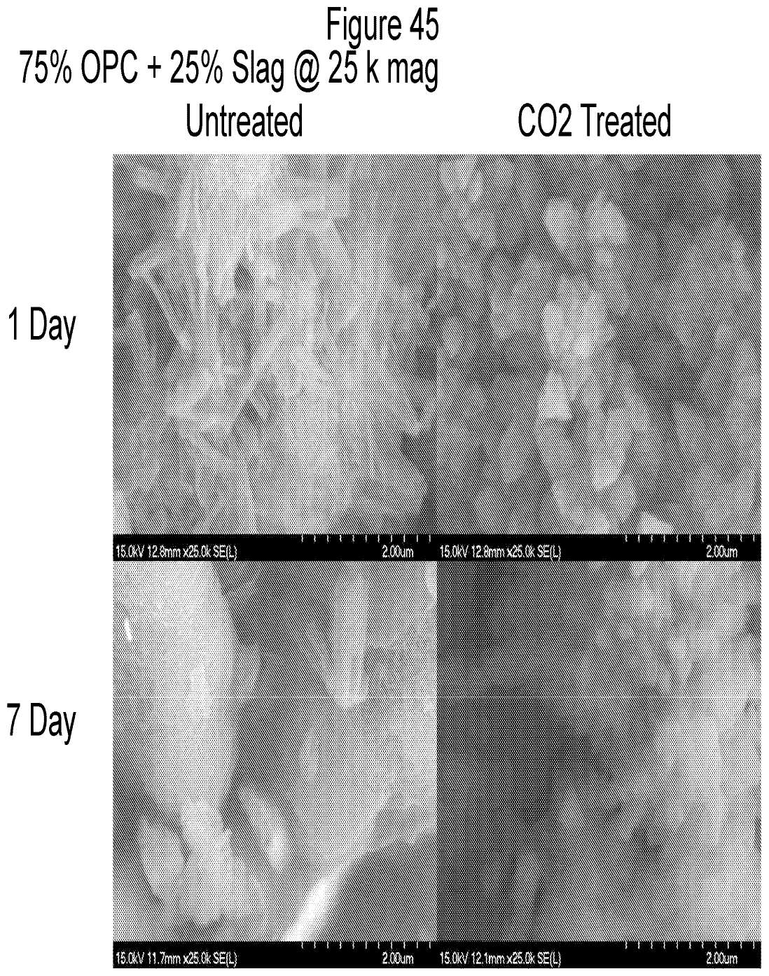

For 75% OPC+25% Slag wash water: At 250 magnification (FIG. 43): Hexagonal particles in untreated cases characteristic of portlandite. Large, faceted, unreacted particles characteristic of slag At 3500 magnification (FIG. 44): Untreated WW: Observe of fuzzy/needle morphology at 1 days which becomes more smooth by 7 days. Additional smaller plat-like morphologies observable at 7 days. Suggests ongoing maturation of the reaction products. At 25,000 magnification (FIG. 45): Untreated WW: mixture of fuzzy and needle-like hydration products characteristic of normal cement hydration. Features mature and become larger by 7-days, hence less detail at 25k magnification in 7-day versus 1-day. CO2 Treated WW: Abundance of small box-like products characteristic of calcite observable at 25 k mag. Microstructure of CO2 treated case appears generally the same between 1 and 7 days of aging.

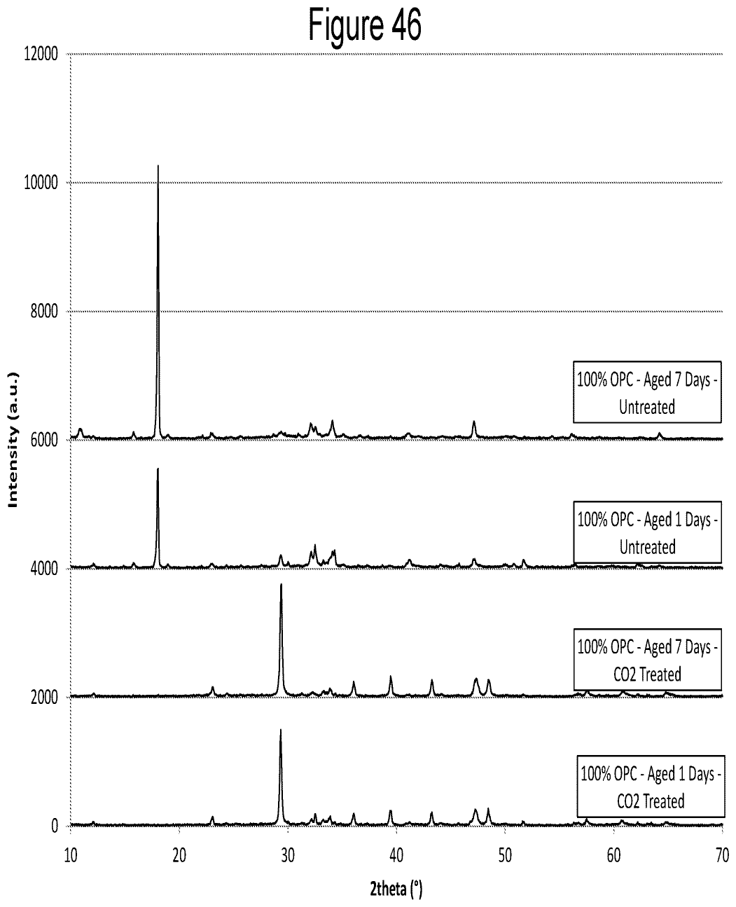

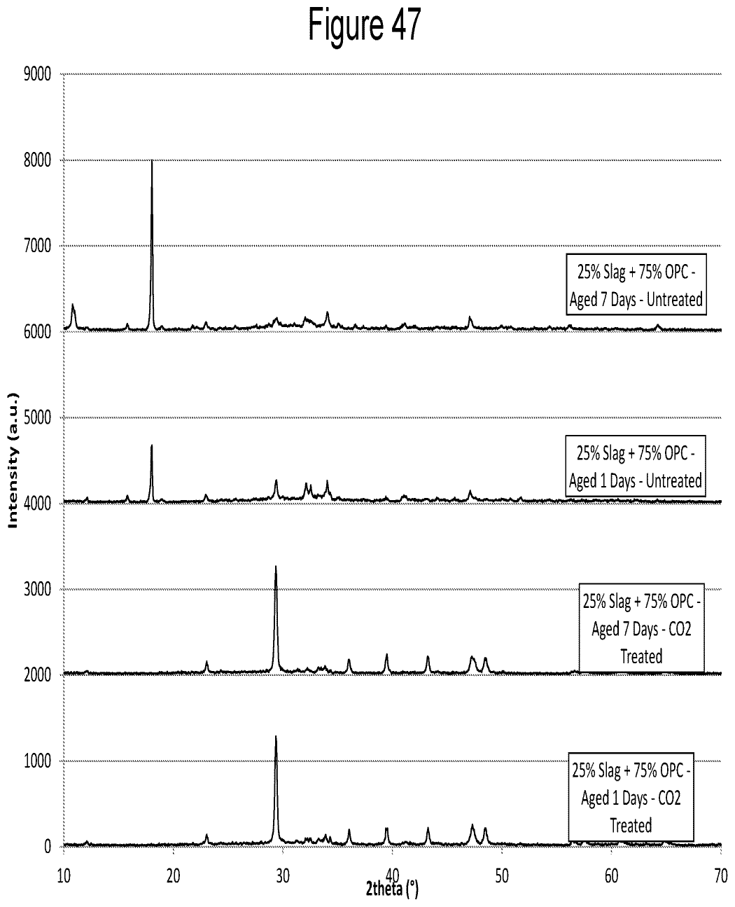

XRD: Untreated WW—Large contribution in the XRD pattern from Ca(OH)₂ with smaller contributions from various calcium silicates and hydration product. CO₂ treated Wash Water—Large contribution in the XRD pattern from CaCO₃ with smaller contributions from various calcium silicates and hydration products. No contribution from Ca(OH)₂. All CaCO₃ is present as calcite, as indicated by large contribution at ˜29° All Ca(OH); is present as portlandite, as indicated by large contribution at ˜18°. See FIGS. 46 and 47.

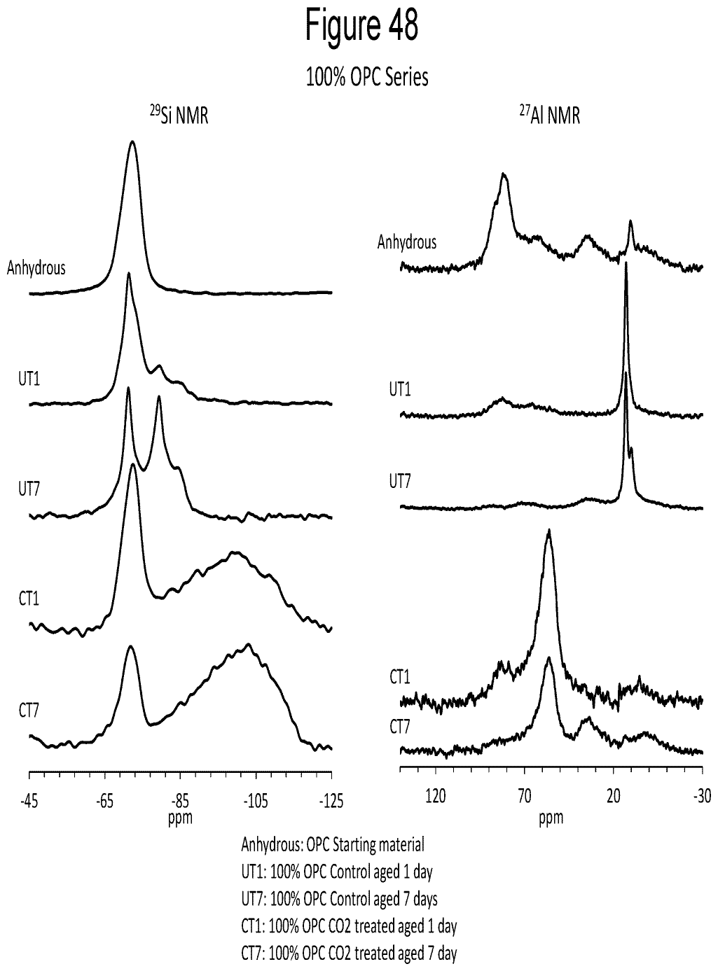

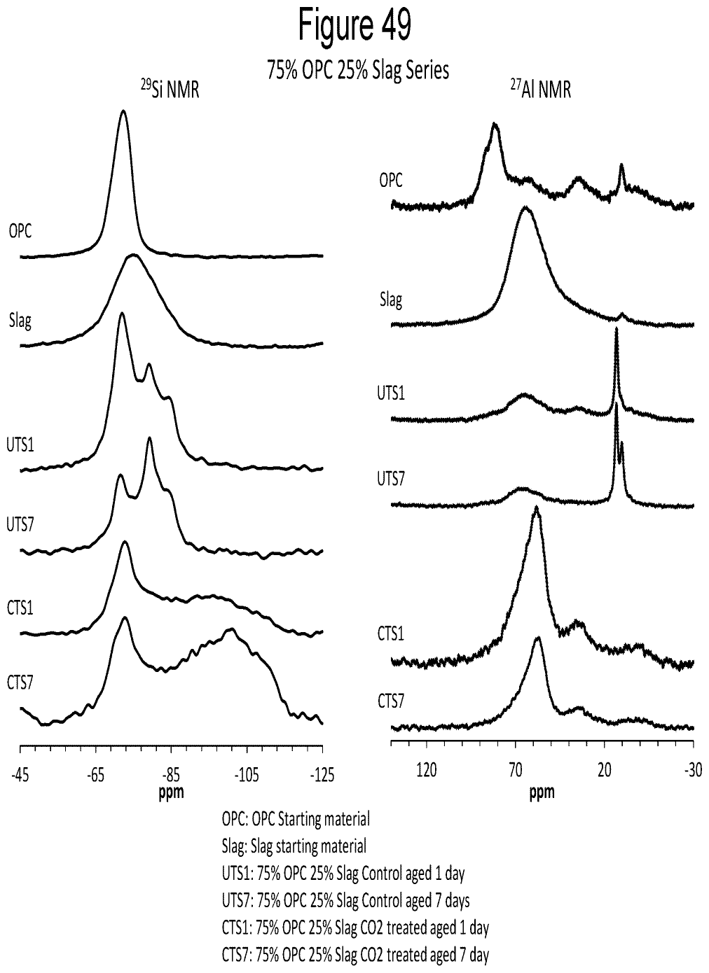

NMR (FIGS. 48 and 49): Silicon: Silicon is present in cement and slag. Unreacted cement phases present in all samples, giving peaks around −70 ppm. Unreacted slag phases are present in all samples, giving peaks around −75 ppm. As the silicates react the silicon signal shifts to more negative values due to polymerization. Untreated WW: Silicon environment in untreated WW changes giving more contribution to signal from −75 to −90, increasing with age This suggests a microstructure that is changing with time. CO₂ Treated WW: Silicon environment in CO₂ treated WW changes dramatically, giving more contribution to signal from −80 to −120, centered around −100

CO2 treated silicon environment displays less change from 1-7 days as compared to untreated case. This suggests different levels of Si polymerization in the CO₂ treated case and less “change” from 1-7 days in the CO₂ treated case.

Aluminum: Aluminum is present in cement and slag. Untreated WW: Al environment in untreated WW produces sharp peak around 10 ppm that changes with sample age. Some signal from unreacted cement Al is visible at 1 day in the 100% OPC case. This suggests a microstructure that is changing with time. CO₂ Treated WW: CO₂ treatment completely modifies Al environment. CO₂ treated Al environment displays less change from 1-7 days as compared to untreated case. This suggests different Al local environment in the CO₂ treated case compared to the untreated case. The untreated case has Al in normal hydration products, like ettringite, while the CO₂ treatment seems to incorporate Al ions into amorphous C-A-S-H phases. The CO₂ treated case demonstrates less “change” in the Al local environment from 1-7 days.

### Example 7

Various wash waters that matched the corresponding mortar mix were either untreated or subject to continuous agitation, with and without carbon dioxide treatment, and the performance of mortar cubes made with the wash water, as described elsewhere herein, was measured.

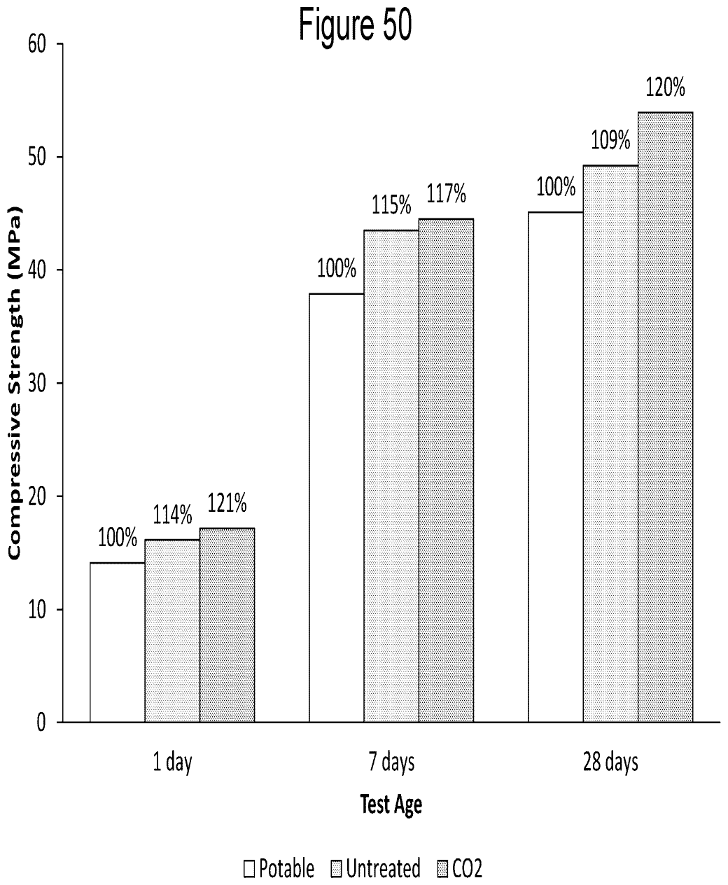

FIG. 50 shows the results for compressive strength of mortar cubes made with one-day old wash water subject to continuous agitation, wash water solids and mortar at 25% slag/75% OPC (Cemex Cemopolis cement). Wash water increased strength compared to control (potable), and carbon dioxide-treated wash water increased strength even more. Slumps were control: 108, Untreated wash water: 45; CO2-treated wash water, 45 (all slumps in mm).

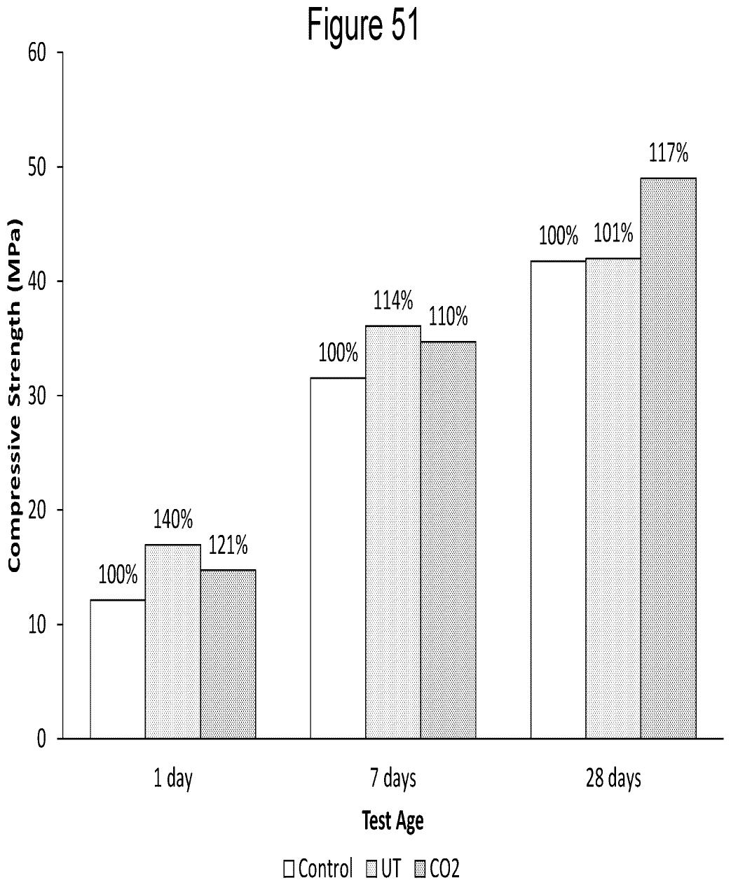

FIG. 51 shows the results for compressive strength of mortar cubes made with one-day old wash water subject to continuous agitation, wash water solids and mortar at 25% class C fly ash/75% OPC (Cemex Cemopolis cement). Wash water increased strength, Untreated wash water was better than CO2 treated wash water at 1 and 7 days, but only the CO2 treated water imparted a strength benefit at 28 days. Slumps were control: 125, Untreated wash water: 90; CO2-treated wash water, 90.

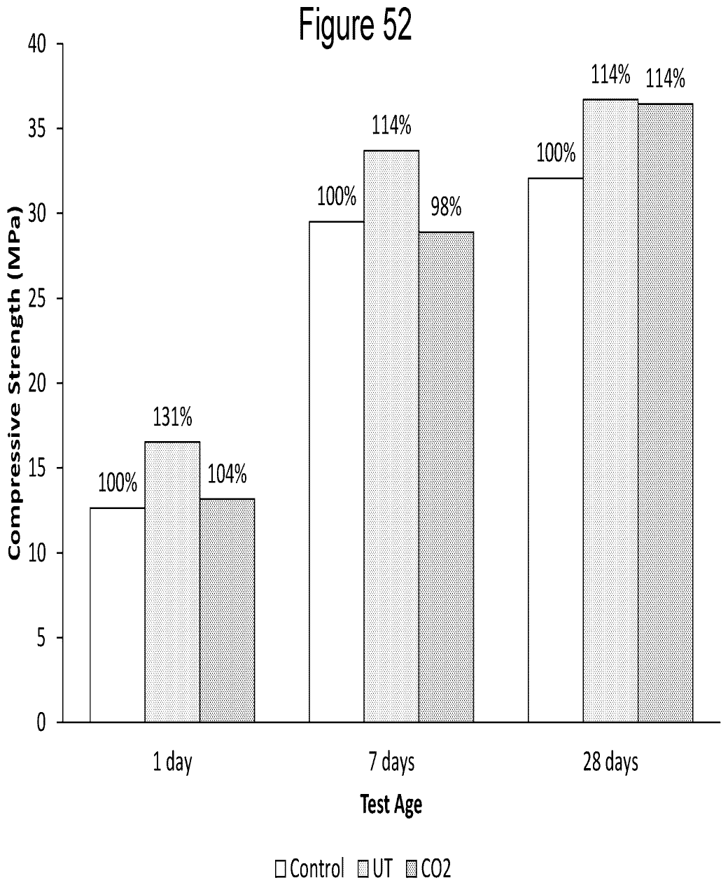

FIG. 52 shows the results for compressive strength of mortar cubes made with one-day old wash water subject to continuous agitation, wash water solids and mortar at 25% class F fly ash/75% OPC (Cemex Cemopolis cement). Wash water increased strength, Untreated wash water was better than CO2 treated wash water at 1 and 7 days, but both showed equal benefit at 28 days. Slumps were control: 118, Untreated wash water: 70; CO2-treated wash water, 90.

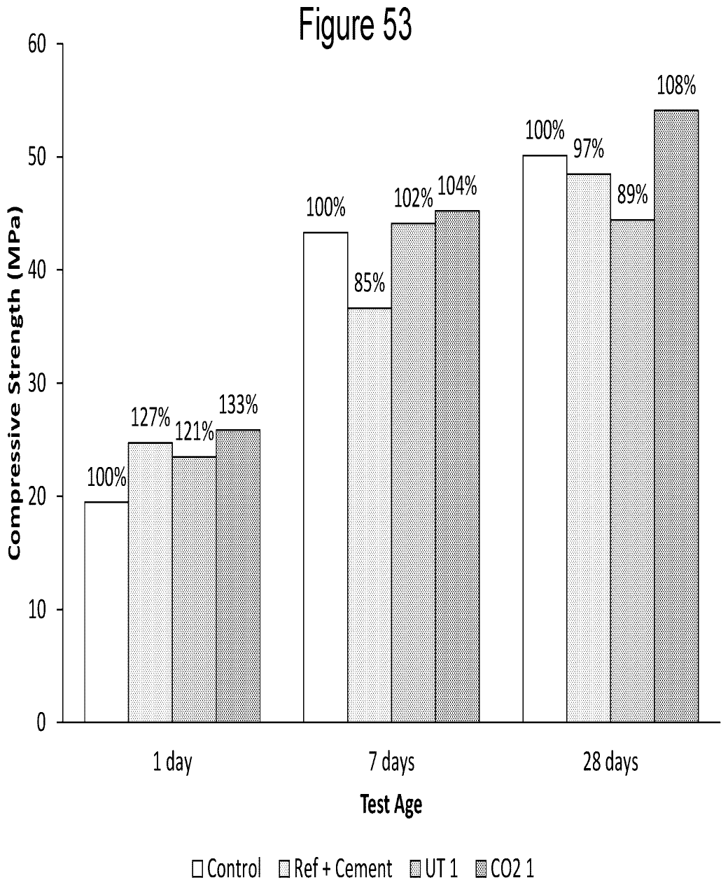

FIG. 53 shows the results for compressive strength of mortar cubes made with one-day old wash water subject to continuous agitation, wash water solids and mortar at 100% OPC (Cemex Cemopolis cement). Reference was extra cement equivalent to the mass of the suspended solids in the wash water. Increased cement improved early but not late strength. CO2 wash water was better than untreated wash water at all ages. CO2 wash water was better than extra cement addition at all ages Slumps were control: 110, Reference with cement: 100; Untreated wash water: 55; CO2-treated wash water, 50.

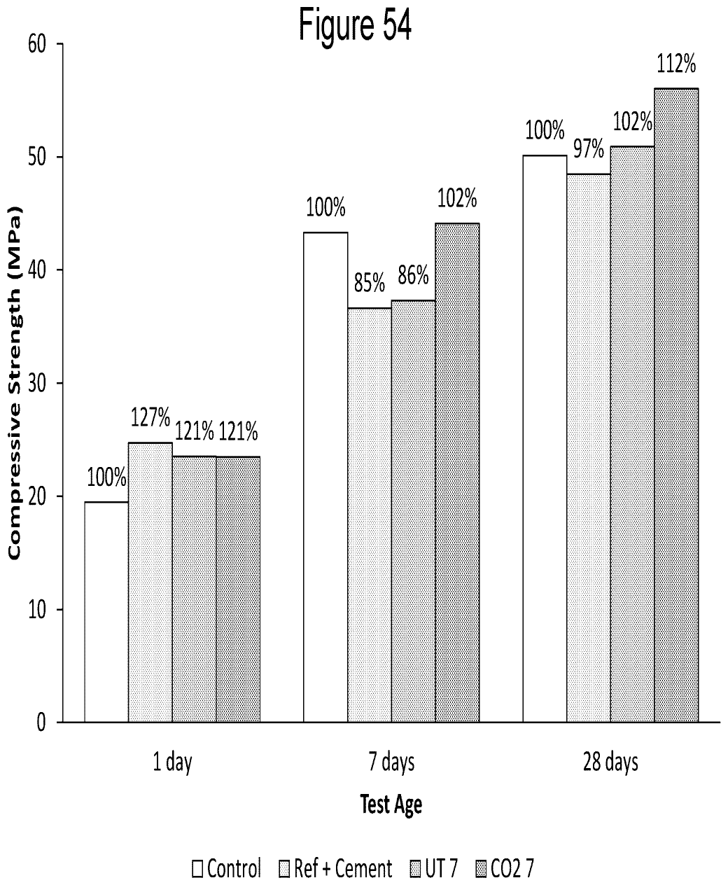

FIG. 54 shows the results for compressive strength of mortar cubes made with seven-day old wash water subject to continuous agitation, wash water solids and mortar at 100% OPC (Cemex Cemopolis cement). Reference was extra cement equivalent to the mass of the suspended solids in the wash water. Increased cement improved early but not late strength. CO2 wash water was equivalent to or better than untreated wash water at all ages. CO2 wash water was better than extra cement addition at later ages, and better than potable water control at 1 and 28 days. Slumps were control: 110, Reference with cement: 100; Untreated wash water: 30; CO2-treated wash water, 60.

### Example 8

Lab scale concrete production compared concrete batches made with potable water, untreated wash water and wash water treated with carbon dioxide. The wash water was used at two ages (1 day and 5 days old). The sample production included three different control batches, each at a different w/c. This allows for interpretations of compressive strength if there is a variation in w/b among the test batches.

TABLE 3
Description of water in batches

| Sample | Mix water | Water Age | Batch |
|---|---|---|---|
| Control L, w/b = 0.56 | Potable water | n/a | 1 |
| Control M, w/b = 0.67 | Potable water | n/a | 4 |
| Control H, w/b = 0.75 | Potable water | n/a | 7 |
| Reference UT1 | Untreated | 1 day | 2 |
| Reference UT5 | Untreated | 5 day | 6 |
| CO2-1 | CO2 treated | 1 day | 3 |
| CO2-5 | CO2 treated | 5 day | 5 |

The wash water was sourced from a ready mixed truck through washing it after it had emptied its load. The collected wash water was sieved past a 80 μm screen and then was bottled (2L plastic bottles). If appropriate, the wash waster was carbonated in the same manner as wash water for the mortar testing (given an excess of CO₂ achieved through periodic topping up and under agitation). The specific gravity of the wash water during carbonation was between 1.20 and 1.25. When used in concrete the water was diluted to a specific gravity of about ˜1.08.

The batches were produced with a total binder loading of 307 kg/m³ including the cement, fly ash, and solids contained within the wash water. The batches with lower and higher w/b ratios deviated from this binder loading. In terms of w/b the binder fraction included the cement, fly ash and solids contained in the wash water. The binder batches was 80% cement and 20% fly ash. Batch comparisons are made relative to the baseline of the Control M batch.

TABLE 4
Concrete mix designs in kg/m³

| | Control | Control | Control | UTWW | UTWW | CO2WW | CO2WW |
|---|---|---|---|---|---|---|---|
| | L | M | H | 1 | 5 | 1 | 5 |
| Cement | 258 | 246 | 221 | 231 | 231 | 231 | 231 |
| Fly Ash | 64 | 61 | 55 | 58 | 58 | 58 | 58 |
| WW Solids | 0 | 0 | 0 | 17 | 18 | 18 | 18 |
| Total Binder | 322 | 307 | 276 | 306 | 307 | 307 | 307 |
| Sand | 847 | 822 | 882 | 822 | 822 | 822 | 822 |
| Stone | 1025 | 995 | 964 | 995 | 995 | 995 | 995 |
| Batch Water | 181 | 207 | 207 | 211 | 207 | 207 | 207 |
| Rel % cement | 105% | 100% | 90% | 94% | 94% | 94% | 94% |
| Rel % fly ash | 105% | 100% | 90% | 94% | 94% | 94% | 94% |
| Rel % binder | 105% | 100% | 90% | 100% | 100% | 100% | 100% |

The wash water batches included less cement and fly ash (each reduced 6%) in a proportion equivalent to the suspended solids contained within the wash water.

The fresh properties were measured and compared relative to the Control M batch.

TABLE 5
Concrete fresh properties

| | Control | Control | Control | UTWW | UTWW | CO2WW | CO2WW |
|---|---|---|---|---|---|---|---|
| | L | M | H | 1 | 5 | 1 | 5 |
| Temperature | 20.1 | 20.3 | 19.4 | 19.8 | 19 | 19.7 | 19.8 |
| (° C.) | | | | | | | |
| Slump (in) | 6.0 | 6.5 | 5.0 | 6.0 | 4.5 | 6.0 | 6.0 |
| Air (%) | 1.8% | 1.5% | 1.1% | 1.6% | 1.1% | 1.6% | 1.2% |
| Unit Mass | 2410 | 2373 | 2381 | 2373 | 2390 | 2376 | 2373 |
| (kg/m3) | | | | | | | |
| Norm Unit Mass | 2454 | 2409 | 2408 | 2411 | 2416 | 2414 | 2402 |
| (kg/m3) | | | | | | | |
| Rel. slump | 92% | 100% | 77% | 92% | 69% | 92% | 92% |
| Relative air | 120% | 100% | 73% | 107% | 73% | 107% | 80% |
| Rel. unit mass | 101% | 100% | 100% | 100% | 101% | 100% | 100% |

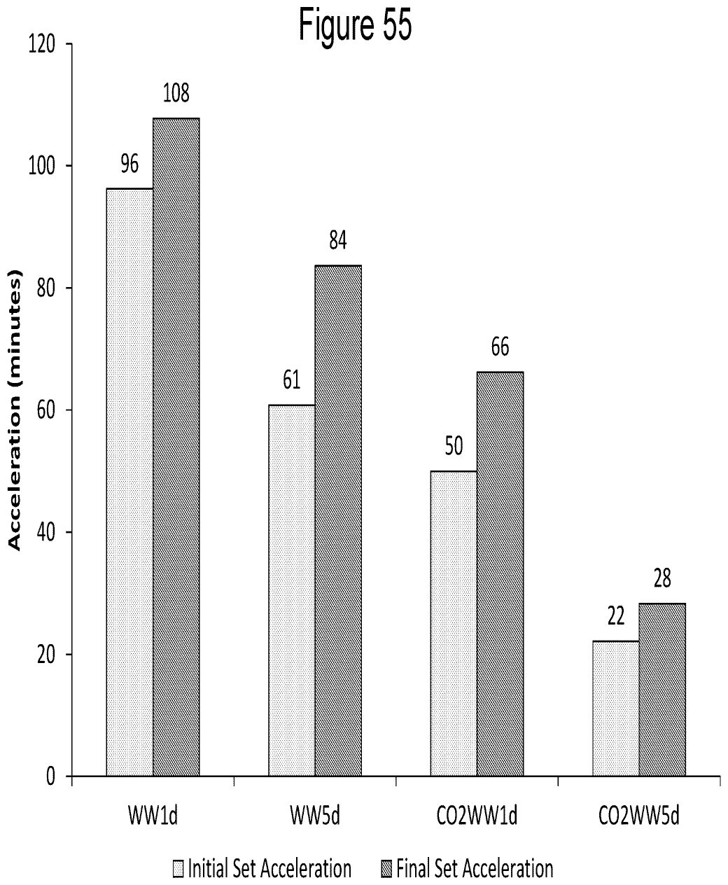

The effects of various treatments on set acceleration of mortar cubes made with the wash waters are shown in FIG. 55. The CO2 reduced the set acceleration. The CO2 reduced the Initial set acceleration by 48% for 1 day wash water, and 64% for 5 day old wash water. The CO2 reduced the Final set acceleration by 39% for 1 day wash water, and 66% for 5 day old wash water.

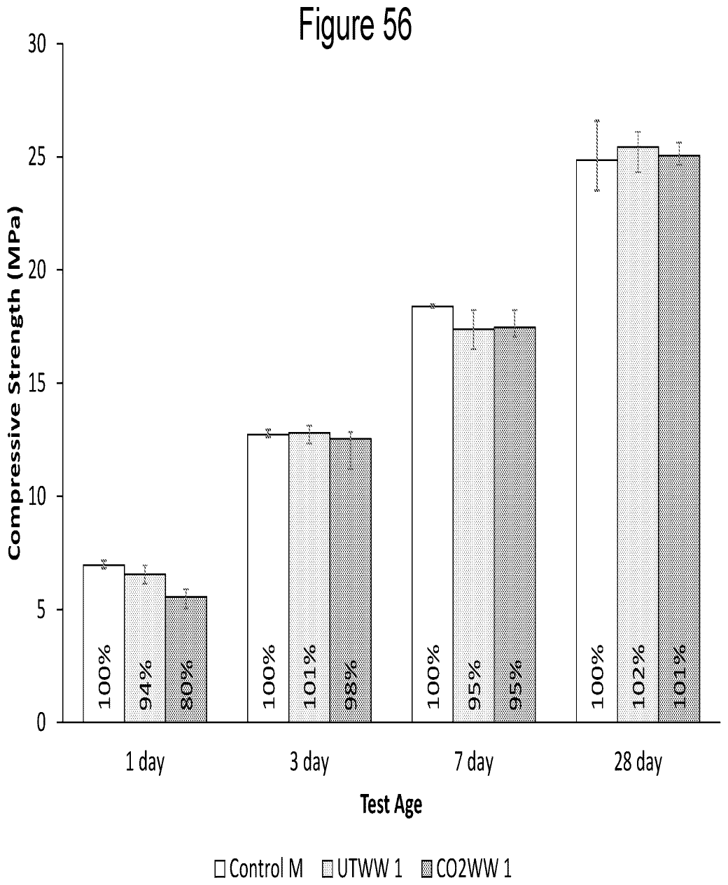

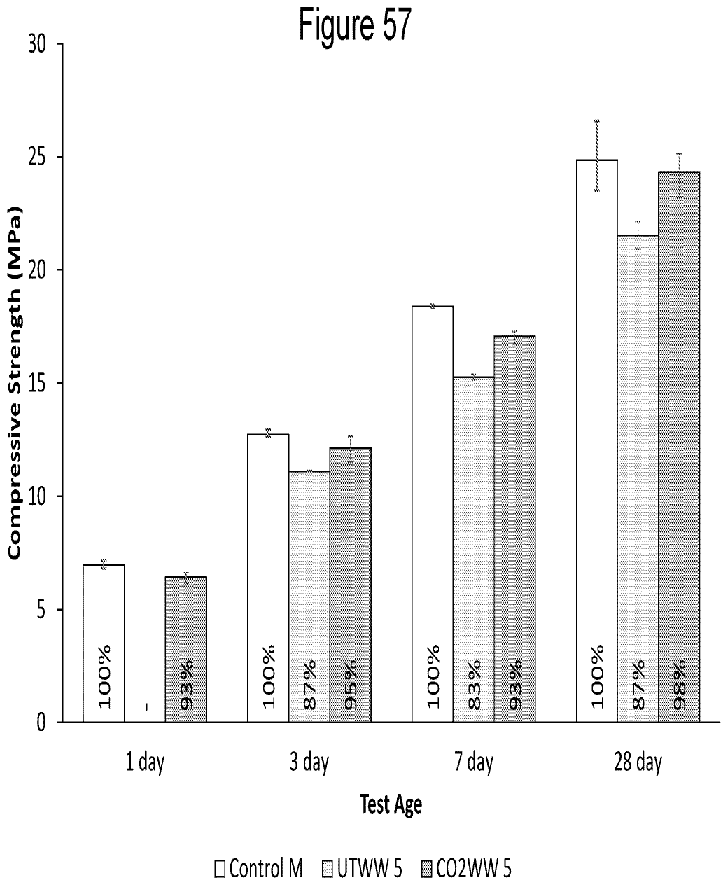

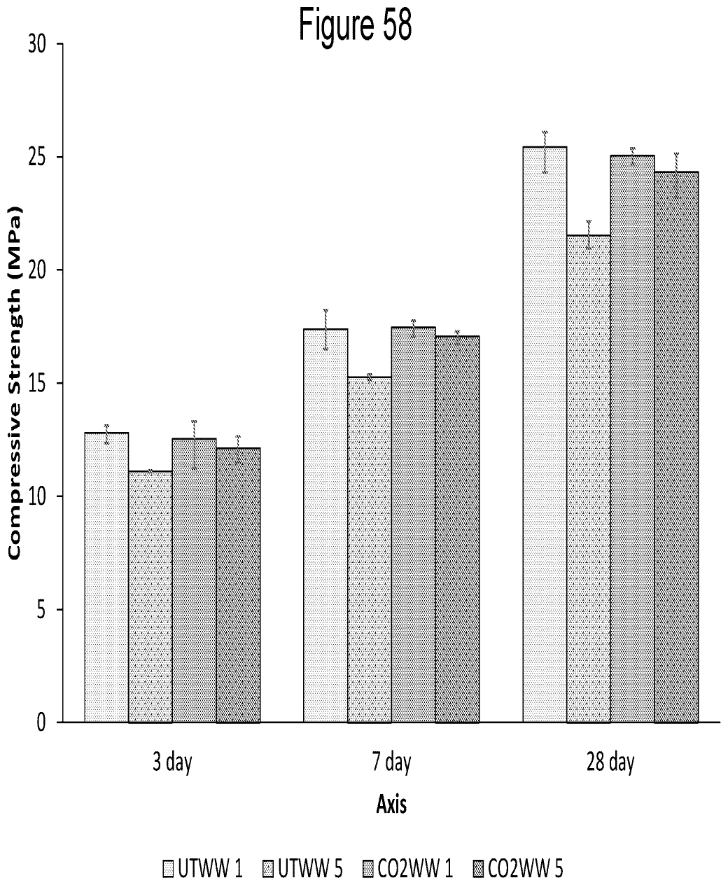

The effects of various treatments on strength of mortar cubes made with the wash waters are shown in FIGS. 56-58. Concrete was an average of 3 specimens in all cases. FIG. 56 shows that for 1 day old wash water the concrete performs equivalent to the control at 28 days. There is 6 percent less binder in the wash water mix designs, so the corresponding amount of wash water solids contributes to the concrete strength. FIG. 57 shows the strength of concrete produced with untreated wash water aged 5 days is 13 to 17% lower than the control concrete (13% lower at 28 days). If the wash water is treated with CO2 the performance relative to the control is only 2 to 7% lower (2% lower at 28 days CO2 improves the strength of concrete produced with 5 day old wash water. FIG. 58 shows increasing the age of the wash water from 1 to 5 days meant the concrete produced with untreated water showed a strength decrease of 12-15%. If the wash water was treated with CO2 the strength with 5 day old wash water was only 2-3% less than with 1 day old wash water.

It appeared that the air content may have been impacted by the wash water. While there was no apparent impact when using 1 old day wash water, both the batches of concrete made with 5 day old wash water (both untreated and CO2 treated) had an air content about 20 to 30% lower than the control. Unit mass and normalized unit mass (normalized for air differences) were consistent among the batches.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1-25. (canceled)

26. An apparatus for carbonating wash water produced in the production of concrete in a wash water operation wherein the wash water comprises cement and/or supplementary cementitious materials (SCM), comprising
(i) a source of carbon dioxide;
(ii) a first conduit operably connected to the source of carbon dioxide that runs to a wash water tank, or to a carbonation site outside the tank, wherein
(a) the wash water container contains wash water from concrete production;
(b) the conduit has one or more openings positioned to deliver carbon dioxide at or under the surface of the wash water in the tank or at the carbonation site outside the tank, to produce carbonated wash water;
(iii) a system for moving the wash water to prevent settling of solids;
(iv) a control system comprising at least one sensor configured to send information to a controller, wherein the controller is configured to process the information from the sensor and to modulate carbon dioxide flow by sending a signal to the one or more actuators based on the information, wherein the sensor is configured to monitor
(a) pH of the wash water,
(b) rate of delivery of carbon dioxide to the wash water,
(c) total amount of wash water in the wash water container,
(d) temperature of the wash water,
(e) specific gravity of the wash water,
(f) concentration of one or more ions in the wash water,
(g) age of the wash water,
(h) circulation rate of the wash water,
(i) timing of circulation of the wash water, or any combination thereof.

27. The apparatus of claim 26 wherein the system for moving the wash water to prevent settling of solids comprises a system to agitate the wash water.

28. The apparatus of claim 26 wherein the system for moving the wash water to prevent settling of solids comprises a system to circulate the wash water.

29. The apparatus of claim 26 wherein the system for moving the wash water to prevent settling of solids is configured to move the wash water continuously.

30. The apparatus of claim 26 wherein the system for moving the wash water to prevent settling of solids is configured to move the wash water intermittently.

31. The apparatus of claim 26 wherein the sensor is configured to monitor pH of the wash water.

32. The apparatus of claim 26 wherein the sensor is configured to monitor rate of delivery of carbon dioxide to the wash water.

33. The apparatus of claim 26 wherein the sensor is configured to monitor specific gravity of the wash water.

34. The apparatus of claim 26 wherein the control system comprises at least two sensors configured to send information to a controller, wherein the controller is configured to process the information from the sensors and to modulate carbon dioxide flow by sending a signal to the one or more actuators based on the information, wherein the sensors are configured to monitor at least two of
(a) pH of the wash water,
(b) rate of delivery of carbon dioxide to the wash water,
(c) total amount of wash water in the wash water container,
(d) temperature of the wash water,
(e) specific gravity of the wash water,
(f) concentration of one or more ions in the wash water,
(g) age of the wash water,
(h) circulation rate of the wash water,
(i) timing of circulation of the wash water, or any combination thereof.

35. The apparatus of claim 26 wherein the control system comprises at least three sensors configured to send information to a controller, wherein the controller is configured to process the information from the sensors and to modulate carbon dioxide flow by sending a signal to the one or more actuators based on the information, wherein the sensors are configured to monitor at least three of
(a) pH of the wash water,
(b) rate of delivery of carbon dioxide to the wash water,
(c) total amount of wash water in the wash water container,
(d) temperature of the wash water,
(e) specific gravity of the wash water,
(f) concentration of one or more ions in the wash water,
(g) age of the wash water,
(h) circulation rate of the wash water,
(i) timing of circulation of the wash water, or any combination thereof.

36. The apparatus of claim 26 further comprising a system to transport the carbonated wash water to a concrete mix operation where the carbonated wash water is used as mix water in a concrete mix.

37. The apparatus of claim 26 wherein the carbon dioxide is delivered to the carbonation site outside the tank, and the apparatus is configured to return the wash water to the tank after carbonation.

38. A method for carbonating concrete wash water comprising
(i) moving the wash water to prevent settling of solids;
(ii) contacting the wash water with carbon dioxide in a tank or at a carbonation site outside the tank, wherein the carbon dioxide is flowed in a conduit operably connected to a source of the carbon dioxide, wherein the conduit has one or more openings positioned to deliver carbon dioxide at or under the surface of the wash water in the tank or at the carbonation site outside the tank, to produce carbonated wash water; and
(iii) monitoring at least one characteristic of the wash water and modulating carbon dioxide flow in the conduit based, at least in part, on the one or more characteristics, wherein the at least one characteristic comprises
(a) pH of the wash water,
(b) rate of delivery of carbon dioxide to the wash water,
(c) total amount of wash water in the wash water container,
(d) temperature of the wash water,
(e) specific gravity of the wash water,
(f) concentration of one or more ions in the wash water,
(g) age of the wash water,
(h) circulation rate of the wash water,
(i) timing of circulation of the wash water, or any combination thereof.

39. The method of claim 38 comprising monitoring at least two characteristics of the wash water and modulating carbon dioxide flow in the conduit based, at least in part, on the at least two characteristics, wherein the at least two characteristics comprise
(a) pH of the wash water,
(b) rate of delivery of carbon dioxide to the wash water,
(c) total amount of wash water in the wash water container,
(d) temperature of the wash water,
(e) specific gravity of the wash water,
(f) concentration of one or more ions in the wash water,
(g) age of the wash water,
(h) circulation rate of the wash water,
(i) timing of circulation of the wash water, or any combination thereof.

40. The method of claim 38 comprising monitoring at least three characteristics of the wash water and modulating carbon dioxide flow in the conduit based, at least in part, on the at least three characteristics, wherein the at least three characteristics comprise
(a) pH of the wash water,
(b) rate of delivery of carbon dioxide to the wash water,
(c) total amount of wash water in the wash water container,
(d) temperature of the wash water,
(e) specific gravity of the wash water,
(f) concentration of one or more ions in the wash water,
(g) age of the wash water,
(h) circulation rate of the wash water,
(i) timing of circulation of the wash water, or any combination thereof.

41. The method of claim 38 wherein the wash water is moved to prevent settling of solids by agitating the wash water.

42. The method of claim 38 wherein the wash water is moved to prevent settling of solids by circulating the wash water.

43. The method of claim 38 wherein the wash water is moved to prevent settling of solids continuously.

44. The method of claim 38 wherein the wash water is moved to prevent settling of solids intermittently.

45. The method of claim 38 further comprising transporting the carbonated wash water to a concrete mix operation where the carbonated wash water is used as mix water in a concrete mix.

46. The method of claim 38 wherein the at least one characteristic is monitored by a sensor.

47. The method of claim 38 wherein the carbonation of the wash water results in carbonation products in the wash water that comprise 1-100% carbon dioxide by weight cement (bwc).

48. The method of claim 38 wherein the carbonation of the wash water results in carbonation products in the wash water that comprise 5-100% carbon dioxide by weight cement (bwc).

49. The method of claim 38 wherein the carbonation of the wash water results in carbonation products in the wash water that comprise 20-100% carbon dioxide by weight cement (bwc).

50. The method of claim 38 wherein the carbonation of the wash water produces calcium carbonate, and wherein at least a portion of the calcium carbonate is present as a solid product with longest dimension of no more than 500 nm.

51. The method of claim 50 wherein at least 1% of the calcium carbonate is present as a solid product with longest dimension of no more than 500 nm.

52. The method of claim 50 wherein at least 10% of the calcium carbonate is present as a solid product with longest dimension of no more than 500 nm.

53. The method of claim 50 wherein at least 50% of the calcium carbonate is present as a solid product with longest dimension of no more than 500 nm.

54. The method of claim 38 comprising contacting the wash water with carbon dioxide at a carbonation site outside the tank, and returning the carbonated wash water to the tank.
